(19) United States
(12) Patent Application Publication
(10) Pub. No.: US 2005/0125688 A1
(43) Pub. Date: Jun. 9, 2005

(54) Policy rule scenario control apparatus and control method

(76) Inventors: Kazuki Ogawa, Kawasaki (JP); Nobuhiro Kawamura, Kawasaki (JP); Seiji Nomiyama, Yokohama (JP); Katsuichi Nakamura, Tosu (JP); Akira Imahase, Yokohama (JP)

Correspondence Address: KATTEN MUCHIN ZAVIS ROSENMAN, 575 MADISON AVENUE, NEW YORK, NY, 10022-2585, US

(21) Appl. No.: 10/827,660

(22) Filed: Apr. 19, 2004

(30) Foreign Application Priority Data
Dec. 4, 2003 (JP) 2003-406124

(51) Int. Cl. H04L 9/00

(52) U.S. Cl. 713/200

(57) ABSTRACT

A policy rule scenario control apparatus comprises a scenario data storing unit storing one or more scenario data produced by combinations of a plurality of types of policy rules and applying conditions of these policy rules, a monitoring unit monitoring an operating state of a network device, a scenario selecting unit selecting the scenario data having the applying condition suitable to the monitor result, and a scenario implementing unit implementing policy control on the network device on the basis of, in the selected scenario data, the policy rule having the applying condition suitable to the monitor result, and implementing the policy control on the network device on the basis of a result of the implementation and another policy rule having the applying condition suitable to a subsequent monitor result. This enables automatically applying the policy rule validly according to the network state varying at all times.

### BACKGROUND OF THE INVENTION

1) Field of the Invention

The present invention relates to an apparatus and method for controlling a policy rule scenario, and more particularly to a technique suitable for use in a policy rule based network control in network operations, such as an IP (Internet Protocol) network and an MPLS (Multi Protocol Label Switching) network, and others.

2) Description of the Related Art

In general, as the recent method for the access to the Internet, there has been known a broadband access system such as ADSL (Asymmetric Digital Subscriber Line). The spread of the broadband access method has called for, for example, broadband information services such as VOD (Video On Demand) and interactive voice communication services such as VoIP (Voice over Internet Protocol). For this reason, Carrier, ISP (Internet Service Provider), IDC (Internet Data Center) and others start to offer these services, which leads to an extreme increase in traffic flowing in network.

Along with the aforesaid increase in traffic, the processing load increases with respect to network equipment, such as router and exchange, constituting the Internet and, hence, the transfer delay or abandonment of packets occurs in the network, which is the cause of the degradation of service quality. Therefore, the Carrier, ISP, IDC and others, which offer the broadband information services or the interactive voice services, have been required to take a network operating measure for providing a stable service quantity to the service users.

A description will be given hereinbelow of a policy server serving as a network operating technique.

The policy server is designed to, when a network operator or manager sets various network operating policies (data) in accordance with a network operating state, automatically bring the set policy to bear on the setting of network equipment internally existing in the network. Each of the various operating policies to be set by the network operator signifies a policy rule comprising a condition (application condition) and a corresponding action. In general, the condition to be set in a conventional policy server is header information in packet, including an IP address, subnet mask and port number in a transmitting side and an IP address, subnet mask and port number in a transmitted side, or it is a policy operating time zone.

These policy data is produced according to a network operating index (guideline) determined in advance by the network operator.

Moreover, as a conventional technique for taking a countermeasure against unauthorized intrusion or attach in a supervisory network, there has been known a technique (manual automatic production, operation acknowledgment system, and method therefor) proposed in Japanese PatenT Laid-Open No. 2002-328894. This technique has been developed in consideration of the fact that the requirements for many patterns exist because the countermeasure varies according to the kind of unauthorized intrusion or attach, a site or time of attach, service system, recovery priority, and others in a supervisory network and difficulty is experienced in writing them in a paper medium in the form of a document and, if the countermeasure procedure increases in quantity and falls into complication, the reference and understanding thereof requires a very lot of labors.

Accordingly, this technique includes a scenario producing unit for acquiring the user's requirements about a damaged situation stemming from a network security and the handling thereof to determine a handling procedure for recovery and produce the contents thereof and a scenario implementing unit for, in a scenario described in a state structured for each operational step, obtaining an operational acknowledgment in unit of the operational step and testing the recovering portion in unit of the operational step to bring it to bear on the scenario. This enables electronically managing the handling manual, automatically producing a handling manual according to the type of network intrusion or attach and displaying it when needed, thus quickly and precisely providing information needed for the recovery.

In addition, so far, as proposed in Japanese Patent Laid-Open No. 2000-311095, in an information processing system such as a multi-function system in which an inputting device such as a scanner or digital camera is used as a data transmitting unit and an outputting device such as a printer or facsimile is used as a data receiving unit so that these data transmitting and receiving units are connected to each other through a network, there has been known a technique capable of carrying out desired recovery processing according to a user's intention without conducting error recovery processing in a given manner.

This technique makes a decision as to whether or not a data transferred device (data receiving device) is in an error status and, if an error occurs, operates a control panel of a scanner to specify a user to acquire a profile corresponding to this user from an management server so that two or more error recovery processing are implemented according to a predetermined priority. Accordingly, even if the data receiving device falls into an error status, the two or more error recovery processing written in the user's profile are conducted in succession when needed, which can eliminate the need for the user to set the processing contents of the error recovery processing for each device and which enables the user to conduct the error recovery processing according to his/her taste through any one of the devices.

Still additionally, as a conventional technique related to error recovery, there has been known a technique (error recovery subsystem and error recovery method) proposed in Japanese Patent No. 3109054. This technique comprises a user editable file including a rule defining a field of a system state of a data processing system and an error status of the data processing system to allow a user to edit the rule and the error status and a means coupled to the user editable file for making a comparison between the system state and an error status to call a recovery operation sequence in accordance with the error status agreeing with the system state, thus changing the error recovery method without compiling the program code of the error recovery subsystem.

The above-mentioned policy rule is to be produced on the basis of a network operating index previously determined by a network administrator. However, the policy rule previously produced is not always available as an valid policy rule, for that various users make communications through the use of diverse applications. For applying a policy rule valid in the actual network state, the network administrator collects information such as traffic and packet loss rate for grasping the actual network state, thus producing/applying a policy rule.

However, extreme difficulty arises when the network administrator applies an optimum policy according to the actual network state at all times. That is, there is a need to prepare a large number of policy rules in advance and select an optimum policy from the prepared policies to apply it.

Incidentally, each of the techniques disclosed in the above-mentioned patent documents is not related to the network policy, and it is impossible to apply a policy rule valid to the actual network state.

### SUMMARY OF THE INVENTION

The prevent invention has been developed in consideration of the above-mentioned problems, and it is therefore an object of the invention to provide a policy rule scenario control apparatus and control method, capable of applying an valid policy rule automatically according to a network state.

For this purpose, a policy rule scenario control apparatus according to an aspect of the present invention is characterized by comprising the following means:
(a) scenario data storing means storing one or more scenario data forming combinations of a plurality of types of policy rules for policy control on a network device and applying conditions of the policy rules;
(b) monitoring means monitoring an operating state of the network device;
(c) scenario selecting means selecting, from the scenario data storing means, the scenario data having the applying condition suitable to a monitor result in the monitoring means; and
(d) scenario implementing means implementing policy control with respect to the network device on the basis of, in the scenario data selected by the scenario selecting means, the policy rule having (associated with) the applying condition suitable to the monitor result, and implementing policy control with respect to the network device on the basis of the implementation result and another policy rule having an applying condition suitable to a subsequent monitor result in the monitoring means.

In addition, a policy rule scenario control apparatus according to another aspect of the present invention is characterized by comprising the following means:
(a) policy data storing means storing a plurality of types of policy rules for policy control on a network device;
(b) scenario data storing means storing one or more scenario data forming combinations of the plurality of types of policy rules and applying conditions of the policy rules;
(c) scenario inputting means receiving the input of the applying conditions of the policy data and combining a plurality of types of policy data in the policy data storing means and the applying conditions to produce the scenario data and register them in the scenario data storing means;
(d) monitoring means monitoring an operating state of the network device;
(e) scenario selecting means selecting, from the scenario data storing means, the scenario data having the applying condition corresponding to a monitor result in the monitoring means; and
(f) scenario implementing means implementing policy control with respect to the network device on the basis of, in the scenario data selected by the scenario selecting means, the policy rule having the applying condition suitable to the monitor result, and implementing policy control with respect to the network device on the basis of the implementation result and another policy rule having the applying condition suitable to a subsequent monitor result in the monitoring means.

Still additionally, a policy rule scenario control method according to a further aspect of the present invention is characterized by comprising the following steps:
(a) storing, in scenario data storing means, one or more scenario data forming combinations of a plurality of types of policy rules for policy control on a network device and applying conditions of the policy rules;
(b) monitoring an operating state of the network device;
(c) selecting, from the scenario data storing means, the scenario data having the applying condition corresponding to the monitor result;
(d) implementing policy control with respect to the network device on the basis of, in the scenario data selected, the policy rule having the applying condition suitable to the monitor result; and
(e) implementing policy control with respect to the network device on the basis of the implementation result and another policy rule having an applying condition suitable to a subsequent monitor result.

Moreover, a policy rule scenario control method according to a further aspect of the present invention is characterized by comprising the following steps:
(a) storing, in policy data storing means, a plurality of types of policy rules for policy control on a network device, and storing, in scenario data storing means, a plurality of scenario data forming combinations of the plurality of types of policy rules and applying conditions of the policy rules;
(b) upon receipt of input of the applying conditions of the policy data, combining a plurality of types of policy data in the policy data storing means and the applying conditions to produce the scenario data and register them in the scenario data storing means;
(c) monitoring an operating state of the network device;
(d) selecting, from the scenario data storing means, the scenario data having the applying condition corresponding to the monitor result;
(e) implementing policy control with respect to the network device on the basis of, in the scenario data selected, the policy rule having the applying condition suitable to the monitor result; and
(f) implementing policy control with respect to the network device on the basis of the implementation result and another policy rule having the applying condition suitable to a subsequent monitor result.

With the policy rule scenario control apparatus and control method according to the present invention, the scenario data which realizes an optimum policy rule selection algorithm according to an operating state (network state) of a network device is freely producible (customized) to realize the network operation (control), the network administrator wants, through the implementation of this scenario, thus coping flexibly with the diverse network operations.

In particular, it is possible to automatically carry out the network control valid in the network state varying momentarily in a flexible and fine fashion, which enables ensuring the network service quality without enhancing the network administrator's load. Moreover, for example, in the case of the failure of the application of the policy rule or in a case in which a policy rule is applied while still failing to improve the network state, a scenario for the application of another policy rule is defined, thereby preventing the network service quality from falling into degradation.

### BRIEF DESCRIPTION OF THE DRAWINGS

FIG. 1 is a block diagram showing an example of a system configuration to which applied is a policy rule scenario control apparatus according to an embodiment of the present invention;

FIG. 2 is an illustration of an example of a data structure of a policy rule in a policy management DB shown in FIG. 1;

FIG. 3 is an illustration of an example of a data structure of a scenario in a scenario management DB shown in FIG. 1;

FIG. 4 is an illustration of an example of a data structure in a network management DB shown in FIG. 1;

FIG. 5 is a sequence illustration useful for explaining policy rule registration processing in a policy server shown in FIG. 1;

FIG. 6 is a sequence illustration useful for explaining scenario registration processing in the policy server shown in FIG. 1;

FIGS. 7(A) and 7(B) are sequence illustrations useful for explaining scenario implementation processing in the policy server shown in FIG. 1;

FIG. 8 is a flow chart useful for explaining processing in a user interface unit shown in FIG. 1;

FIG. 9 is a flow chart useful for explaining processing in a policy managing unit shown in FIG. 1;

FIG. 10 is a flow chart useful for explaining processing in a policy applying unit shown in FIG. 1;

FIG. 11 is a flow chart useful for explaining processing in a policy analyzing unit shown in FIG. 1;

FIG. 12 is a flow chart useful for explaining processing in a scenario analyzing unit shown in FIG. 1;

FIG. 13 is a flow chart useful for explaining processing in a scenario implementing unit shown in FIG. 1;

FIG. 14 is a flow chart useful for explaining processing in a policy application indicating unit shown in FIG. 1;

FIG. 15 is a flow chart useful for explaining processing in a scenario inputting unit shown in FIG. 1;

FIG. 16 is a flow chart useful for explaining processing in a monitor point setting unit shown in FIG. 1;

FIG. 17 is a flow chart useful for explaining processing in a polling unit shown in FIG. 1;

FIG. 18 is a flow chart useful for explaining processing in a trap unit shown in FIG. 1;

FIG. 19 is a flow chart useful for explaining processing in a management information managing unit shown in FIG. 1;

FIG. 20 is an illustration of a concrete example 1 of a network configuration useful for explaining a scenario implementing method in a policy server shown in FIG. 1;

FIG. 21 is an illustration of a data structure and content example of a policy rule in the concrete example 1 shown in FIG. 20;

FIG. 22 is an illustration of a data structure and content example of a scenario in the concrete example 1 shown in FIG. 20;

FIG. 23 is an illustration of a concrete example 2 of a network configuration useful for explaining a scenario implementing method in the policy server shown in FIG. 1;

FIG. 24 is an illustration of a data structure and content example of a policy rule in the concrete example 2 shown in FIG. 23;

FIG. 25 is an illustration of a data structure and content example of a scenario in the concrete example 2 shown in FIG. 23;

FIG. 26 is an illustration of a concrete example 3 of a network configuration useful for explaining a scenario implementing method in the policy server shown in FIG. 1;

FIG. 27 is an illustration of a data structure and content example of a policy rule in the concrete example 3 shown in FIG. 26;

FIG. 28 is an illustration of a data structure and content example of a scenario in the concrete example 3 shown in FIG. 26;

FIG. 29 is an illustration of a concrete example 4 of a network configuration useful for explaining a scenario implementing method in the policy server shown in FIG. 1;

FIG. 30 is an illustration of a data structure and content example of a policy rule in the concrete example 4 shown in FIG. 29;

FIG. 31 is an illustration of a data structure and content example of a scenario in the concrete example 4 shown in FIG. 29;

FIG. 32 is an illustration of an example of a data inputting screen (scenario registering screen) useful for explaining a scenario production procedure in the policy server shown in FIG. 1;

FIG. 33 is an illustration of an example of a data inputting screen (policy rule adding screen) useful for explaining a scenario production procedure in the policy server shown in FIG. 1;

FIG. 34 is an illustration of an example of a data inputting screen (condition inputting screen) useful for explaining a scenario production procedure in the policy server shown in FIG. 1;

FIG. 35 is an illustration of an example of a data inputting screen (input contents confirming screen) useful for explaining a scenario production procedure in the policy server shown in FIG. 1; and

FIG. 36 is an illustration of an example of a data inputting screen (scenario confirming screen) useful for explaining a scenario production procedure in the policy server shown in FIG. 1.

### DESCRIPTION OF THE PREFERRED EMBODIMENTS

[A] Outline

A policy rule scenario control apparatus and control method according to the present invention enables the application of a policy rule according to a condition by defining a scenario for the policy rule application. A concrete example will be described hereinbelow with reference to Tables 1 and 2.

TABLE 1

| | | ACTION | | |
|---|---|---|---|---|
| SINGLE | | PATH | FLOW | MAIL |
| POLICY RULE | CONDITION | SWITCHING | BLOCKING | NOTIFICATION |
| POLICY RULE #1 | OCCURRENCE OF INDIVIDUAL LINE | • | | |
| | TROUBLE | | | |
| POLICY RULE #2 | OCCURRENCE OF INDIVIDUAL LINE | | • | |
| | TROUBLE | | | |
| POLICY RULE #3 | OCCURRENCE OF INDIVIDUAL LINE | | | • |
| | TROUBLE | | | |
| POLICY RULE #4 | EXCEEDING TRAFFIC THRESHOLD | • | | |
| | FOR INDIVIDUAL LINE | | | |
| POLICY RULE #5 | EXCEEDING TRAFFIC THRESHOLD | | • | |
| | FOR INDIVIDUAL LINE | | | |
| POLICY RULE #6 | EXCEEDING TRAFFIC THRESHOLD | | | • |
| | FOR INDIVIDUAL LINE | | | |
| POLICY RULE #7 | EXCEEDING TRAFFIC THRESHOLD | • | | |
| | FOR INDIVIDUAL LINE | | | |
| POLICY RULE #8 | EXCEEDING TRAFFIC THRESHOLD | | • | |
| | FOR INDIVIDUAL LINE | | | |
| POLICY RULE #9 | EXCEEDING TRAFFIC THRESHOLD | | | • |
| | FOR INDIVIDUAL LINE | | | |

TABLE 2
POLICY RULE SCENARIO IMPLEMENTATION EXAMPLE

| | ALLOCATED POLICY | |
|---|---|---|
| PATH NAME | RULE | SCENARIO |
| TUNNEL #1 | POLICY RULE #1 | IF! (APPLY POLICY |
| | | RULE #1 TO TUNNEL #1) |
| | | APPLY POLICY RULE #2 |
| | | TO TUNNEL #1 |
| | POLICY RULE #2 | |

The table 1 shows an example of a patterned network policy rule related to traffic engineering. As the Table 2 shows, a scenario is defined in terms of an application manner with respect to two types of policy rules #1 and #2 allocated to a path name “tunnel #1”. In this case, the scenario is defined so as to apply and evaluate the policy rule #1=“policy rule for implementing path switching at the occurrence of trouble or obstacle in unit of line” and, if a failure occurs, to apply the policy rule #2=“policy rule for implementing flow blocking at the occurrence of line trouble”. This scenario allows the application of the policy rule #2 based on a result of application of the policy rule #1.

### [B] Description of an Embodiment

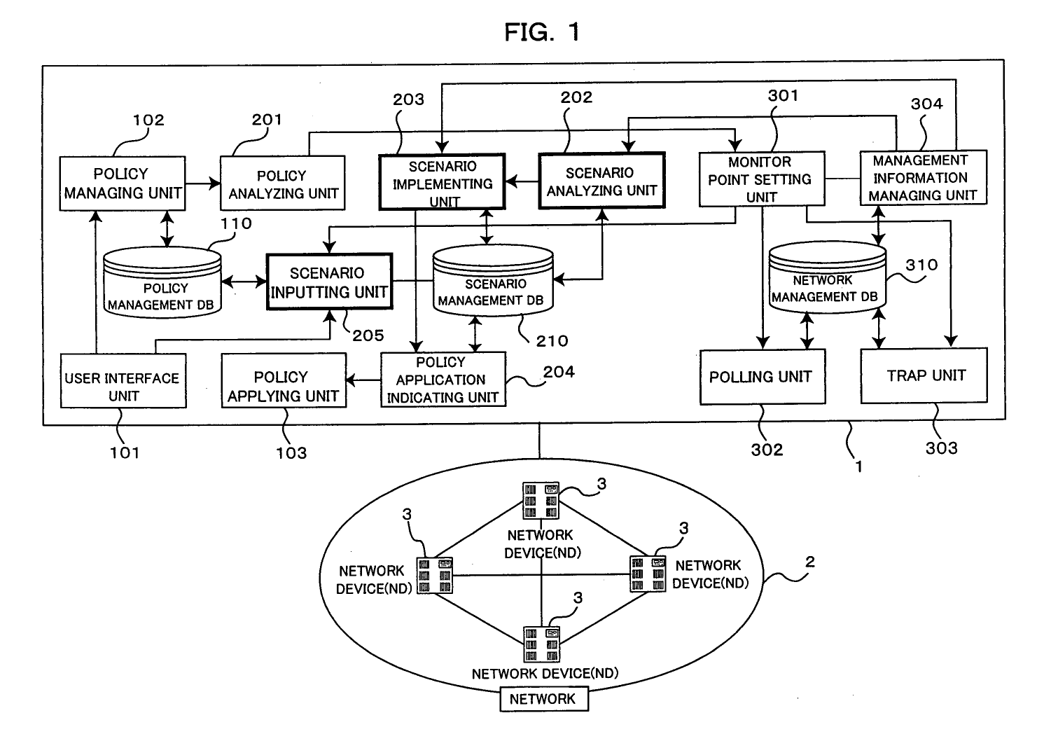

FIG. 1 is a block diagram showing an example of a system configuration to which applied is a policy rule scenario control apparatus according to an embodiment of the present invention. The system shown in FIG. 1 is constructed in a manner such that a policy server 1 having a function as the policy rule scenario control apparatus according to this embodiment is connected to a network 2 equipped with one or more network devices 3 and designed such that a desired policy rule is set from the policy server 1 with respect to the network device(s) 3.

Therefore, for example, as shown in FIG. 1, the policy server 1 according to this embodiment is made up of a user interface unit 101, a policy managing unit 102, a policy applying unit 103, a policy management database (DB) 110, a policy analyzing unit 201, a scenario analyzing unit 202, a scenario implementing unit 203, a policy application indicating unit 204, a scenario inputting unit 205, a scenario management database (DB) 210, a monitor point setting unit 301, a polling unit 302, a trap unit 303, a management information managing unit 304 and a network management database (DB) 310. In this configuration, the scenario analyzing unit 202, the scenario implementing unit 203, the scenario inputting unit 205, the scenario management DB 210 and the management information managing unit 304 function as the aforesaid policy rule scenario control apparatus.

The user interface unit 101 is for providing a user interface which is used when a network administrator produces and/or registers a policy rule and/or a scenario, and the policy managing unit 102 has a function to register and manage, in the policy management DB 110, a policy rule (data) the network administrator produces through the user interface unit 101, and the policy applying unit 103 has a function to carry out the network control according to a policy rule indicated by the policy application indicating unit 204 with respect to a given network device 3.

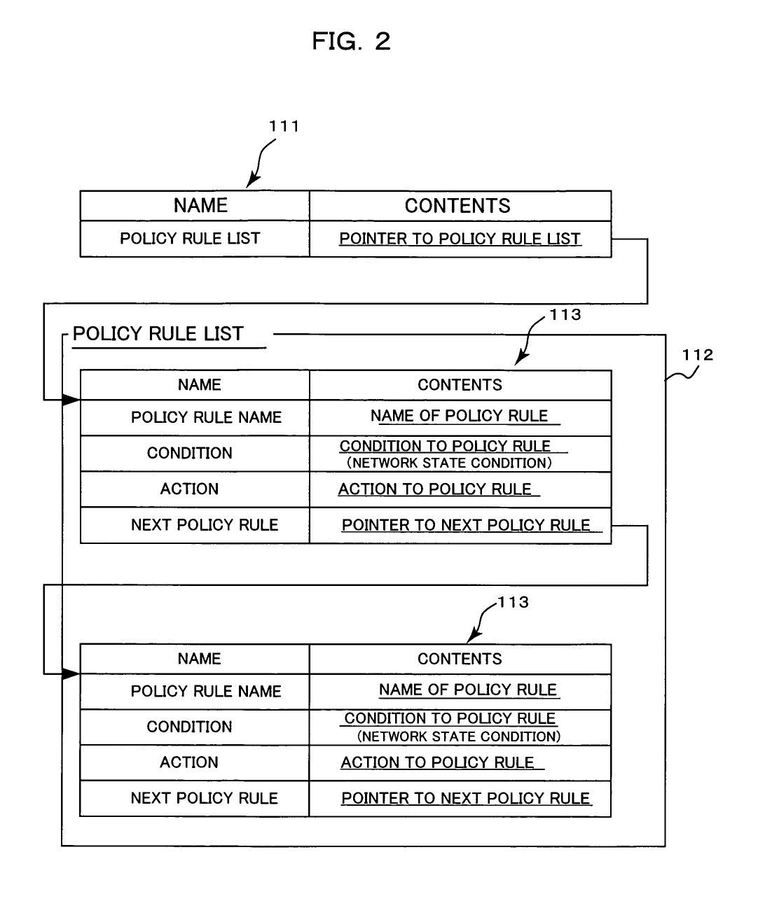

The policy management DB (policy data storing means) 110 is made to store and manage the aforesaid policy rule, for example, in the form of a data structure shown in FIG. 2. That is, the policy management DB 110 is made to store and manage one or more policy rule lists 112, in which one or more policy rule (data) 113 including “policy rule name”, “condition”, “action”, “next policy rule (pointer)” and others are linked to each other through the use of a pointer structure, in a manner such that the policy rule lists 112 are linked through a pointer structure for each “name” 111 or the like, and the reference to the policy rule data 113 can finally be made as its contents by following the pointers on the basis of the policy rule list name 111.

The policy analyzing unit 201 has a function to analyze a policy rule registered through the policy managing unit 102 for making the association between diverse policy rules and network operating states, and the scenario analyzing unit (scenario selecting means) 202 has a function to read out a scenario list from the scenario management DB 210 on the basis of information on the network operating state notified by the management information managing unit 304 to detect (select) a scenario corresponding to (suitable to) a network state monitor result notified by the management information managing unit 304 for issuing a scenario implementation request to the scenario implementing unit 203, and the scenario implementing unit 203 has a function to analyze the scenario from the scenario analyzing unit 202 for issuing an applying request on a policy rule satisfying an applying condition to the policy application indicating unit 204.

The policy application indicating unit 204 has a function to send the policy rule, requested by the scenario implementing unit 203, to the policy applying unit 103 for making a request for the application to the network device 3 and store the policy rule application result as a policy rule application state in the scenario management DB 210, and further to, when receiving a request for a change of the application state of the policy rule from the scenario implementing unit 203, change the application state of the policy rule stored in the scenario management DB 210.

The scenario inputting unit 205 has a function to, when receiving a policy rule acquisition request from the user interface unit 101, notify a policy rule registered in the policy management DB 110 and manage, through the use of the scenario management DB 210, scenarios (one or more scenario data comprising combinations of a plurality of policy rules for the policy control on the network device 3 and applying conditions of the policy rules) the network administrator produces through the user interface unit 101, and further to associate various scenarios with network operating states.

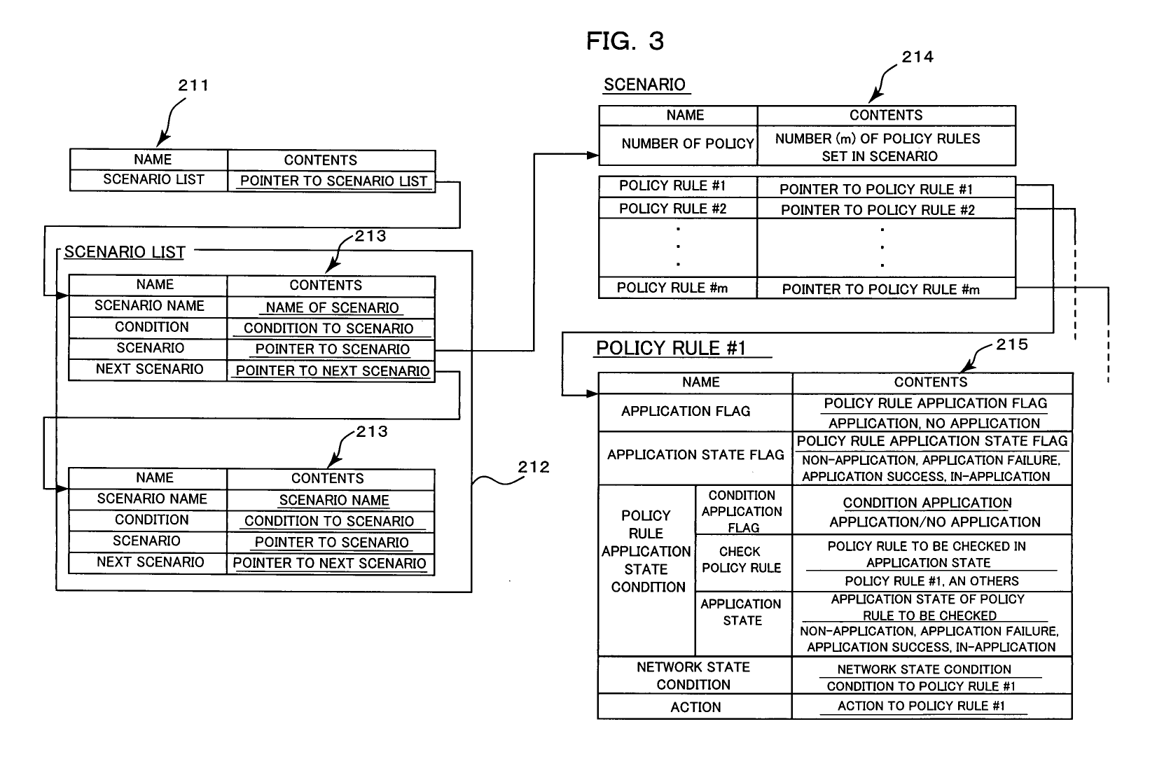

The scenario management DB (scenario data storing means) 210 is for storing and managing the aforesaid scenarios, for example, in the form of a data structure shown in FIG. 3. That is, this scenario management DB 210 is made to store and manage a scenario list 212 having one or more scenario reference data (data including “scenario name”, “condition”, “scenario (pointer)”, “next scenario (pointer)” and others) 213 comprising “scenario name”, “condition”, “scenario (pointer)”, “next scenario (pointer)” and others for each name 211 of the scenario list 212 or the like, and further to store/manage scenario data (“number of policy rules”, “pointer to each policy rule #m (m denotes a natural number)) 214, in which one or more policy rules (data) 215 are linked through pointers, for each scenario reference data 213 of that scenario list 212. Accordingly, by following the pointers successively from the policy rule list name 211, the reference to the scenario 214 and the policy rule 215 linked therewith can finally be made as its contents.

In the policy rule 215 (#m), there are registered “application flag” (information indicative of one of application/no application), “application state flag” (information indicative of one of non-application/application failure/application success/in-application), “policy rule application state condition” [information including “condition application flag” (information indicative of one of application/no application), “policy rule to be checked” (policy rule number #m), “application state” (information indicative of one of non-application/application failure/application success/in-application)], “network state condition” (condition for policy rule #m), and “action” (action for policy rule #m), and others.

The monitor point setting unit 301 has a function to, when network operating state monitoring information such as traffic and packet loss rate is required because of a request from the policy analyzing unit 102 and the scenario inputting unit 205, make a request for the collection or accumulation of that monitoring information to the polling unit 302 and further to, when there is a need for network operating state monitoring information such as trouble information, make a request for the collection of that monitoring information to the trap unit 303.

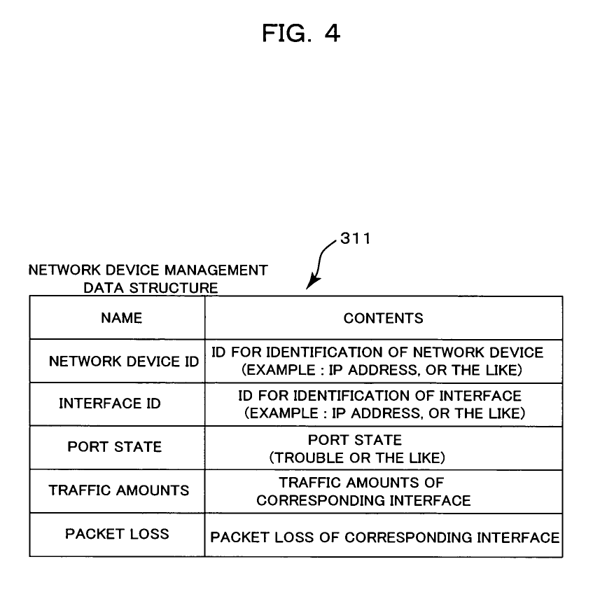

The polling unit 302 has a function to store, in the network management DB 310, the network operating state information such as the traffic or packet loss rate of the network device 3 which is an object of monitor, and the network management DB 310 is for storing and managing this network operating state information, for example, in the form of a data structure shown in FIG. 4. That is, as shown in FIG. 4, the network management DB 310 is made to store and manage various information including a network device identifier (ID) (for example, IP address), an interface ID (for example, IP address), a port state (trouble and the like), a traffic of that interface, a packet loss quantity of that interface, and others.

The trap unit 303 has a function to store the network operating state information such as trouble information in the network management DB 310, and the management information managing unit (monitoring means) 304 has a function to periodically check the network operating state information from the network management DB 310 and further to, if a variation of the network operating state occurs, notify the network operating state information as a monitor result to the scenario analyzing unit 202.

The above-mentioned functions of the respective parts are realizable in a manner such that a CPU (not shown) of the server 1, or the like, internally includes a policy rule scenario control program (software) or reads out it from an outer recording medium such as hard disk, flexible disk or magnet optical disk, alternatively, receives it through a communication line such as the Internet.

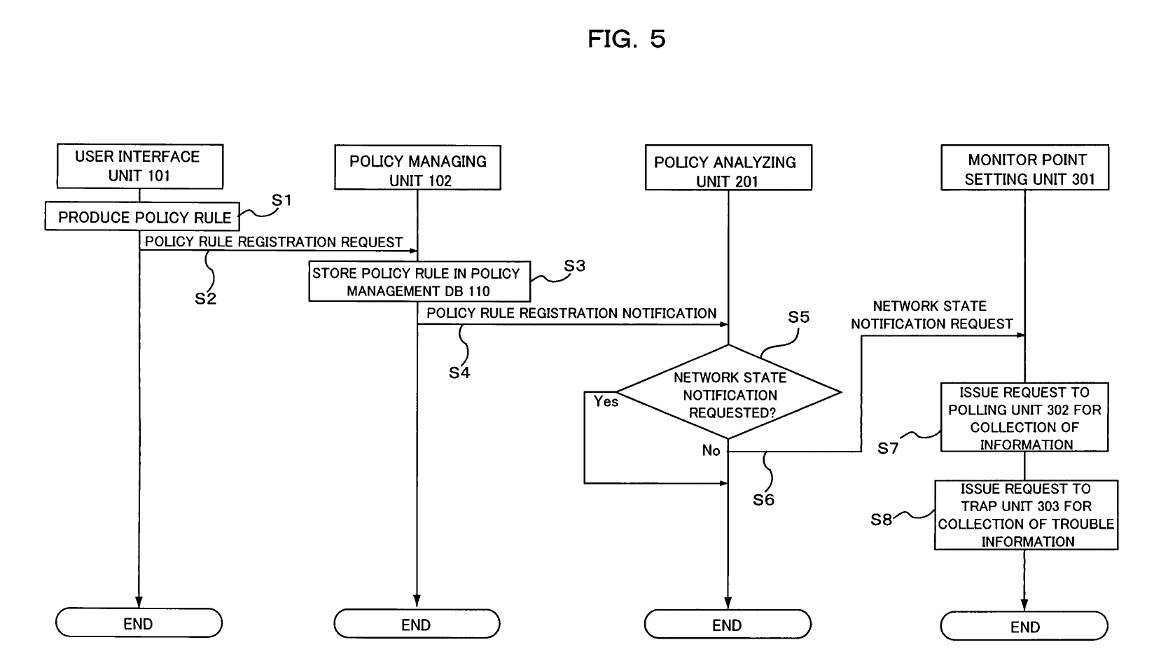

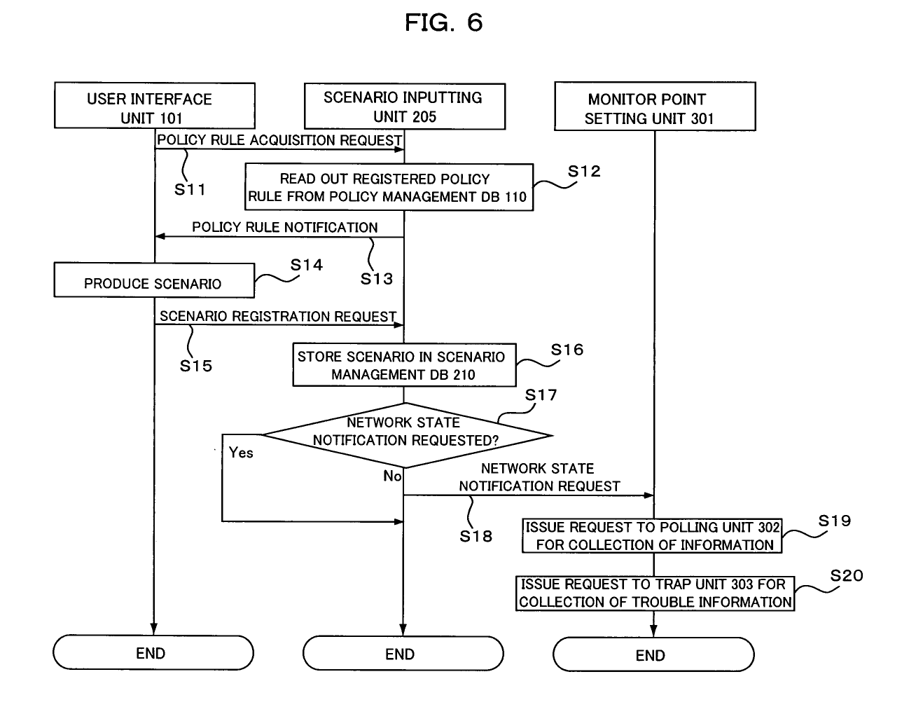

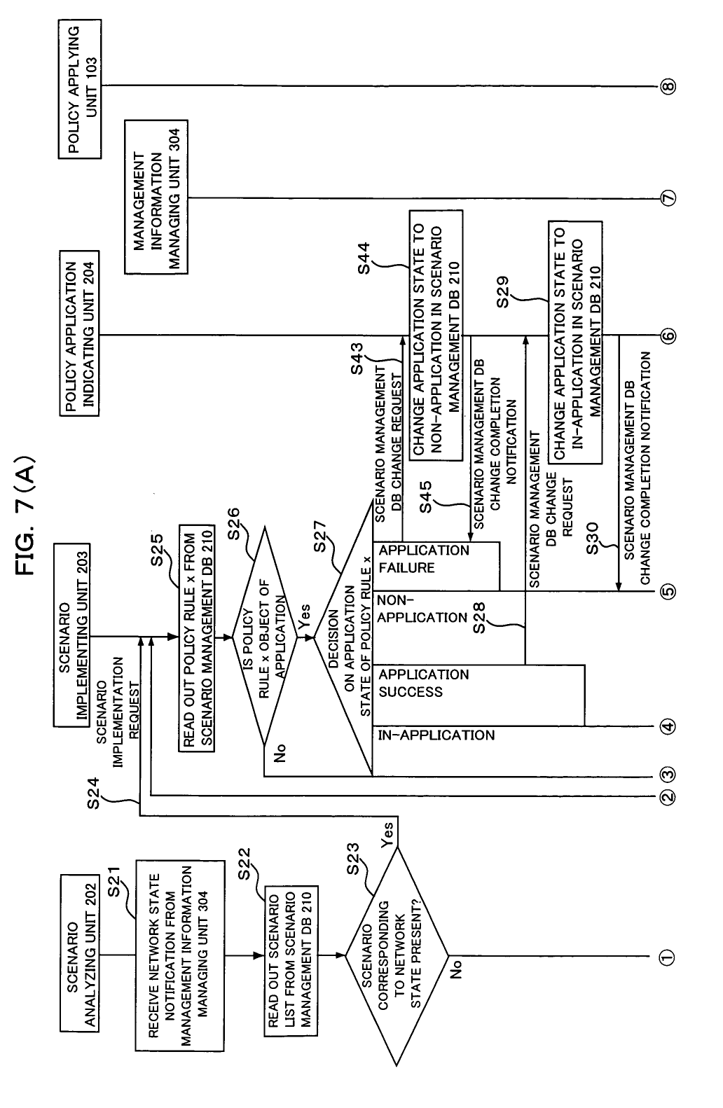

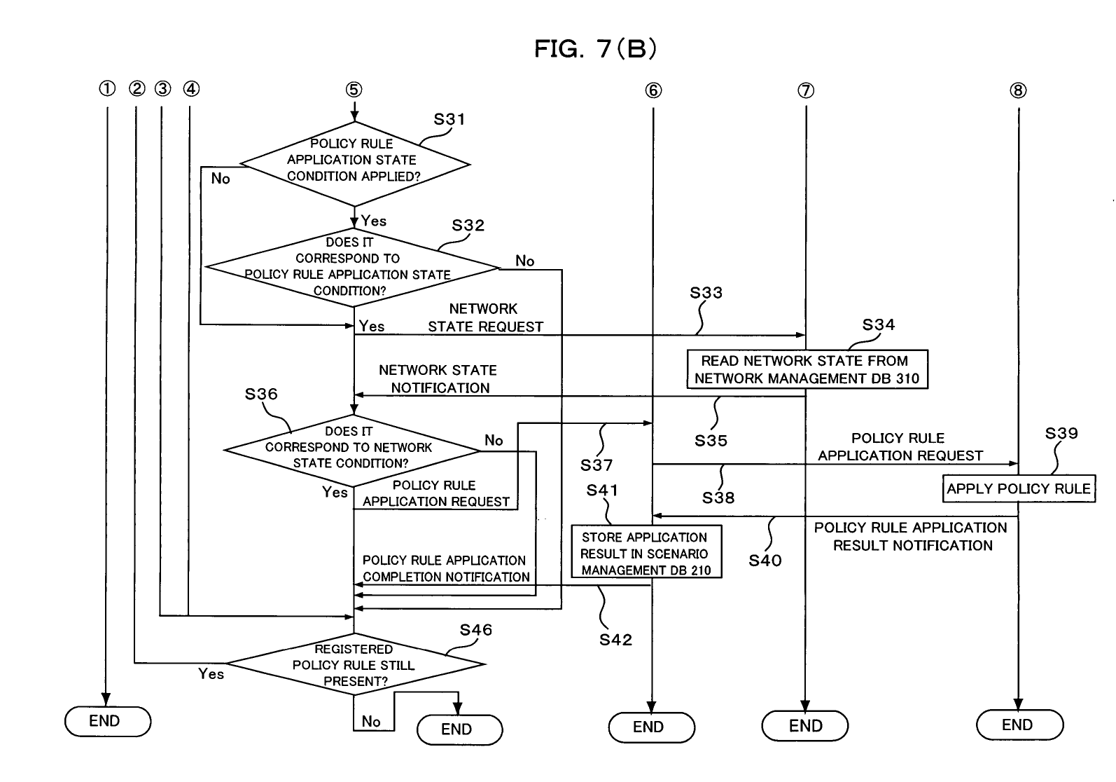

Referring to FIGS. 5 to 19, a detailed description will be given hereinbelow of an operation of the server 1 thus constructed according to this embodiment. FIG. 5 is an illustration of a policy rule registration processing sequence in the policy server 1, FIG. 6 is an illustration of a scenario registration processing sequence in the policy server 1, and FIGS. 7(A) and 7(B) are illustrations of a scenario implementation processing sequence in the policy server 1.

(B1) Policy Rule Registration Processing

First of all, a description will be given hereinbelow of the processing to be conducted for the policy rule registration.

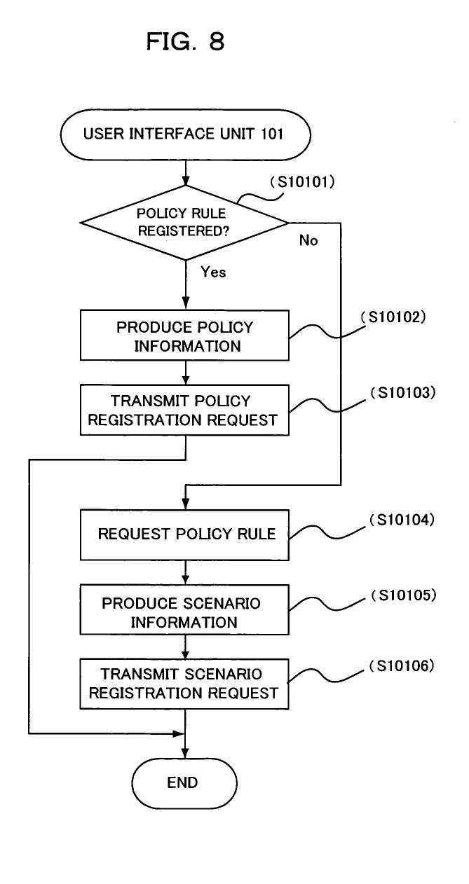

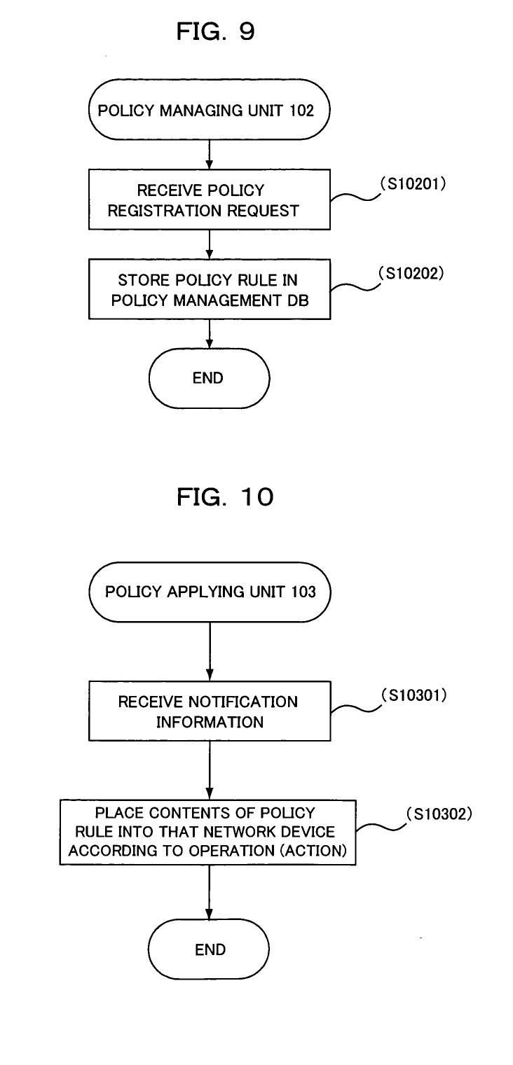

The network administrator produces a policy rule through the user interface unit 101 (step S1 in FIG. 5, and Yes route of step S10101 to step S10102 in FIG. 8), and makes the registration of the policy rule. The policy rule, which is an object of registration request, is sent as a policy registration request to the policy managing unit 102 for processing (step S2 in FIG. 5, and step S10103 in FIG. 8). The policy managing unit 102 stores the registration request policy rule in the policy management DB 110 (step S3 in FIG. 5, and steps S10201 and S10202 in FIG. 9), and notifies the fact of the policy rule registration to the policy analyzing unit 201 (step S4 in FIG. 5).

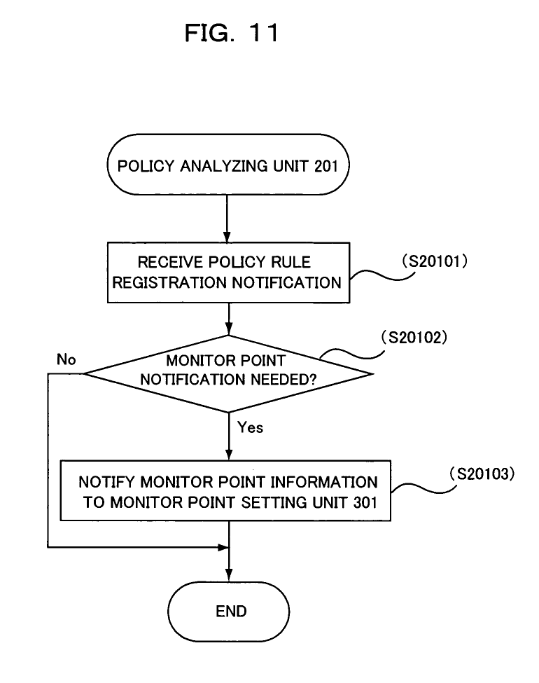

Upon receipt of this notification, the policy analyzing unit 201 (step S20101 in FIG. 11) makes a decision as to whether or not a network state notification request has already been issued with respect to a network device 3 being an object of monitor as a condition of the policy rule and an interface (not shown) of this network device 3 (step S5 in FIG. 5, and step S20102 in FIG. 11). If already requested, the policy analyzing unit 201 terminates this processing (Yes route of step S5 in FIG. 5, and No route of step S20102 in FIG. 11). On the other hand, if not requested yet, it issues a network state notification request to the monitor point setting unit 301 (No route of step S5 to step S6 in FIG. 5, and Yes route of step S20102 to step S20103 in FIG. 11).

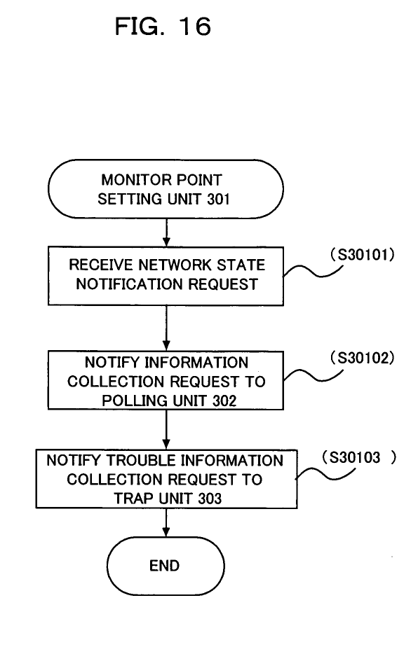

Upon receipt of this network state notification request, the monitor point setting unit 301 (step S30101 in FIG. 16) makes a request to the polling unit 302 for the setting on the collection of information such as traffic and packet loss rate in the network device 3 being an object of monitor as a condition of the designated policy rule and the interface of this network device 3 (step S7 in FIG. 5, and step S30102 in FIG. 16), and makes a request to the trap unit 303 for the setting on the trap of trouble information for the purpose of the collection of the trouble information (step S8 in FIG. 5, and step S30103 in FIG. 16).

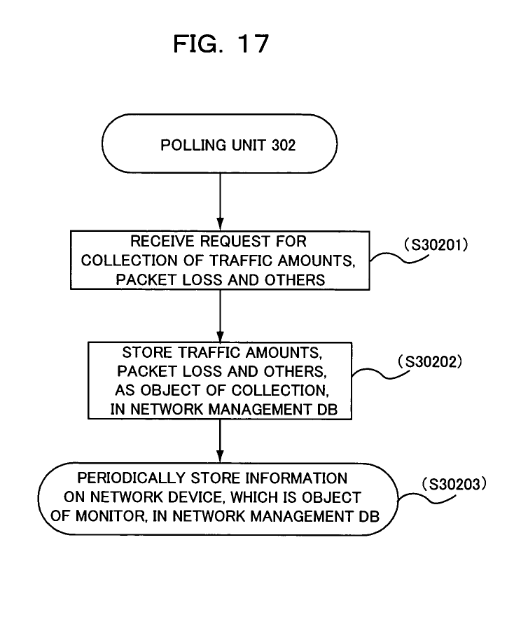

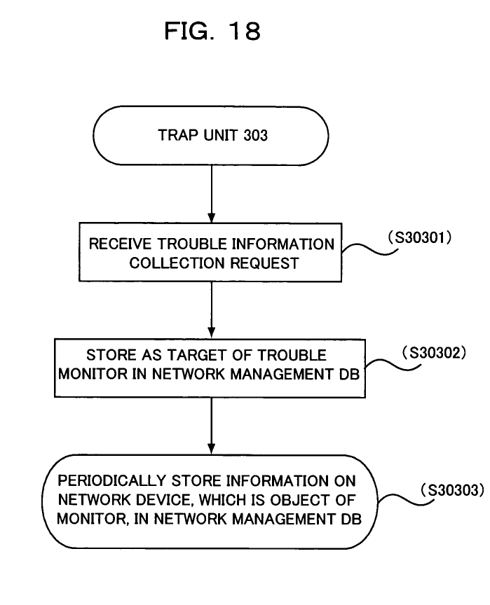

When receiving the request for the collection of traffic, packet loss rate and the like, the polling unit 302 (step S30201 in FIG. 17) collects the requested network state information and stores the collected information in the network management DB 310 (steps S30202 and S30203 in FIG. 17). Moreover, when receiving a request for the collection of trouble information, the trap unit 303 (step S30301 in FIG. 18) collects the requested network information and stores the information collected at the occurrence of troubles in the network management DB 310 (steps S30302 and S30303 in FIG. 18).

(B2) Scenario Registration Processing

Secondly, a description will be given hereinbelow of the processing to be conducted for the scenario registration.

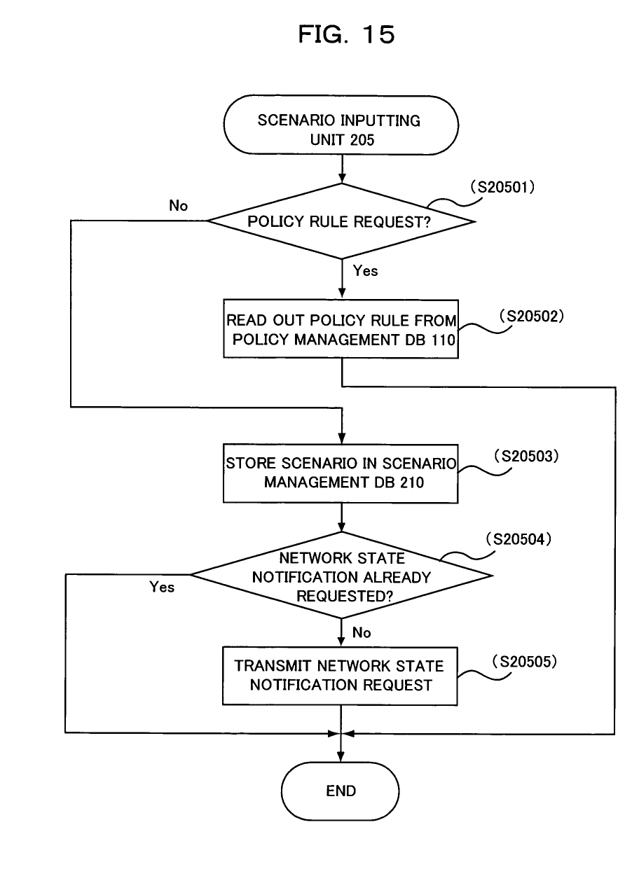

The network administrator produces a scenario through the user interface unit 101. The user interface unit 101 issues, as a policy acquisition request, a request to the scenario inputting unit 205 for the notification on a policy rule registered in the policy management DB 110 (step S11 in FIG. 6). Upon receipt of this request, the scenario inputting unit 205 reads out the registered policy rule from the policy management DB 110 (step S12 in FIG. 6, and Yes route of step S20501 to step S20502 in FIG. 15) and notifies it to the user interface unit 101 (step S13 in FIG. 6, and No route of step S10101 to step S10104 in FIG. 8).

The network administrator produces a scenario comprising a combination of the registered policy rule and the condition for the determination of the scenario (step S14 in FIG. 6, and step 10105 in FIG. 8). The produced scenario is delivered as a scenario registration request to the scenario inputting unit 105 for processing (step S15 in FIG. 6, and step 10106 in FIG. 8). The scenario inputting unit 205 stores the registration-requested scenario in the scenario management DB 210 (step S16 in FIG. 6, and No route of step S20501 to step S20503 in FIG. 15).

Moreover, the scenario inputting unit 205 makes a decision as to whether or not a network state notification request has already been issued with respect to the network device 3 being an object of monitor as a condition of the scenario and an interface of this network device 3 (step S17 in FIG. 6, and step S20504 in FIG. 15). If already requested, the scenario inputting unit 205 terminates this processing (Yes route of step S17 in FIG. 6, and Yes route of step S20504 in FIG. 15). On the other hand, if not requested yet (No decision in step S17 in FIG. 6, and No decision in step S20504 in FIG. 15), it issues a network state notification request to the monitor point setting unit 301 (step S18 in FIG. 6, and step S20505 in FIG. 15).

Upon receipt of the network state notification request, the monitor point setting unit 301 (step S30101 in FIG. 16) makes a request to the polling unit 302 for the setting for the collection of information such as traffic and packet loss rate in the network device 3 being an object of monitor as a condition of the designated scenario and the interface of this network device 3 (step S19 in FIG. 6, and step S30102 in FIG. 16), and makes a request to the trap unit 303 for the setting of trap of trouble information for the purpose of the collection of the trouble information (step S20 in FIG. 6, and step S30103 in FIG. 16).

When receiving the request for the collection of traffic, packet loss rate and the like, the polling unit 302 (step S30201 in FIG. 17) collects the requested network state information and stores the collected information in the network management DB 310 (steps S30202 and S30203 in FIG. 17). Moreover, when receiving a request for the collection of trouble information, the trap unit 303 (step S30301 in FIG. 18) collects the requested network information and stores the information collected at the occurrence of troubles in the network management DB 310 (steps S30302 and S30303 in FIG. 18).

(B3) Scenario Implementation Processing

Furthermore, a description will be given hereinbelow of the processing to be conducted for the scenario implementation.

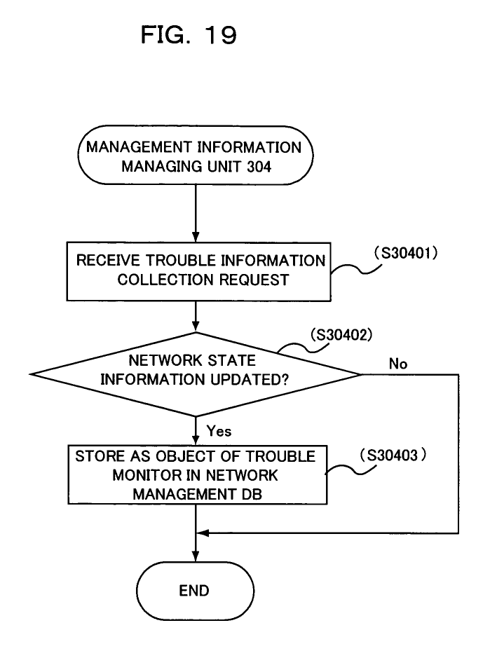

Since the above-mentioned scenario registration processing accomplishes the setting for the collection of the network information, such as the traffic and packet loss rate, and the trouble information in the network device 3 being an object of monitor as a condition of the scenario and the interface of this network device 3, the management information managing unit 304 operates periodically to make a decision as to whether the network state information is updated or not and, if it is updated, transmits the network state notification to the network analyzing unit 202 (step S30401, and Yes route of step S30402 to step S30403 in FIG. 19). On the other hand, if not updated (No decision in step S30402), the management information managing unit 304 waits until the next decision timing.

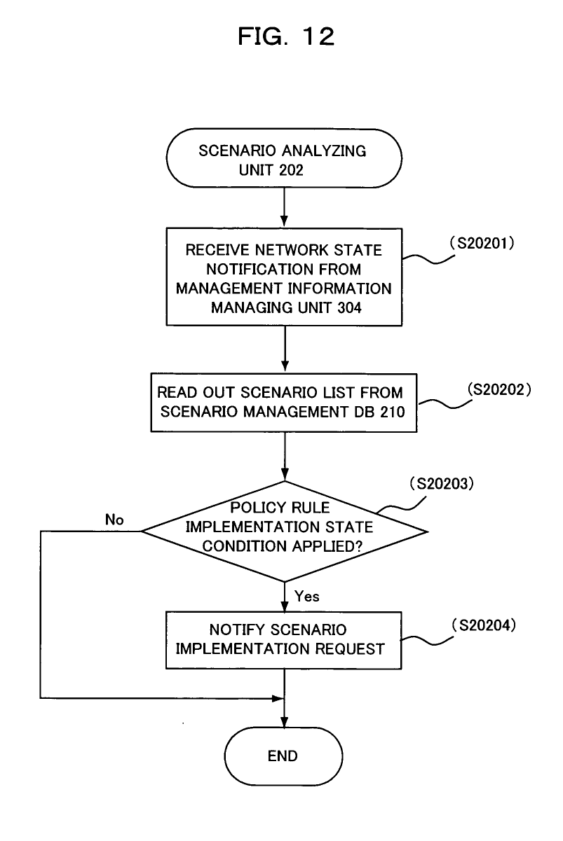

Upon receipt of the network state notification, the scenario analyzing unit 202 (step S21 in FIG. 7(A), and step S20201 in FIG. 12) reads out the scenario list from the scenario management DB 210 (step S22 in FIG. 7(A), and step S20202 in FIG. 12), and makes a decision as to whether or not there is the scenario (policy rule to be applied) corresponding to the information notified through the use of the network state notification from the management information managing unit 304 (step S23 in FIG. 7(A), and step S20203 in FIG. 12). If there is no scenario corresponding to the notified network state, the scenario analyzing unit 202 terminates the processing (No route of step S23 in FIG. 7(A), and No route of step S20203 in FIG. 12). On the other hand, if there is the corresponding scenario (Yes decision in step S23 in FIG. 7(A), and Yes decision in step S20203 in FIG. 12), the scenario analyzing unit 202 issues a scenario implementation request to the scenario implementing unit 203 (step S24 in FIG. 7(A), and step S20204 in FIG. 12).

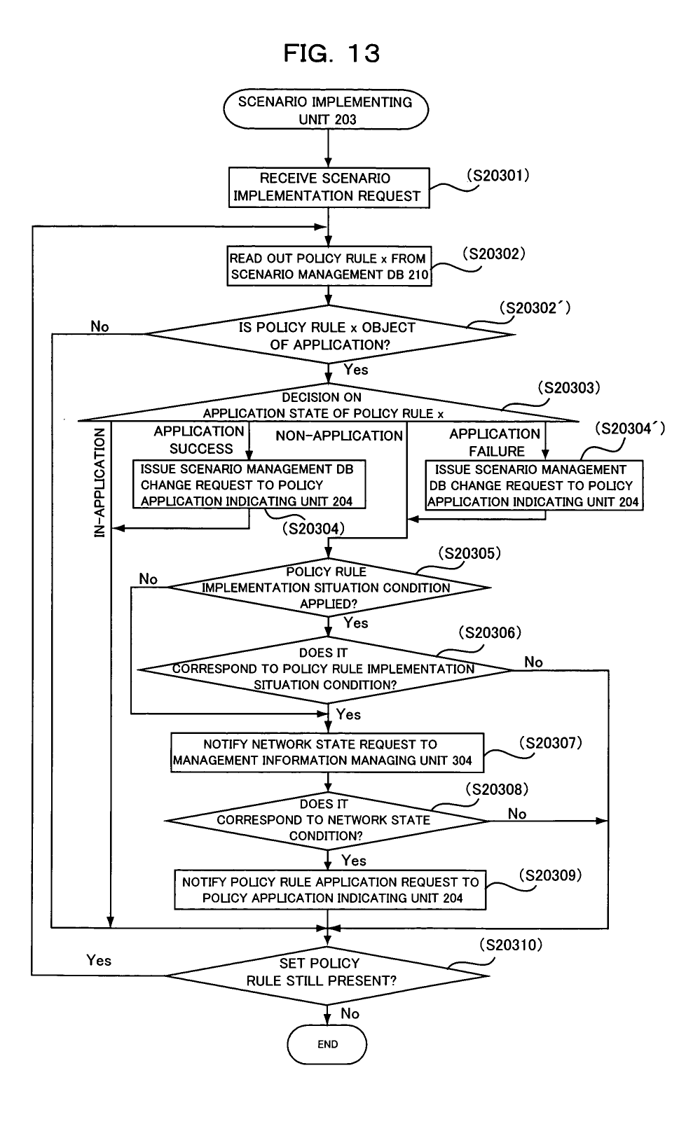

In response to the scenario implementation request (step S20301 in FIG. 13), the scenario implementing unit 203 reads out the policy rules registered in this scenario from the scenario management DB 210 (step S25 in FIG. 7(A), and step S20302 in FIG. 13) to analyze them one by one. That is, first, a decision is made as to the application of the policy rule (x=#1 to #m) (step S26 in FIG. 7(A), and step S20302′ in FIG. 13). In the case of no application thereof, the analysis of this policy rule (x) comes to an end (No route of step S26 in FIG. 7(A) and No route of step S20302′ in FIG. 13). On the other hand, in the case of the application (Yes route of step S26 in FIG. 7(A) and Yes route of step S20302′ in FIG. 13), the scenario implementing unit 203 then checks “application state” of this policy rule (x) (step S27 in FIG. 7(A), and step S20303 in FIG. 13). In consequence, if this policy rule (x) has already been applied (“in-application”), the scenario implementing unit 203 terminates the analysis of this policy rule (x).

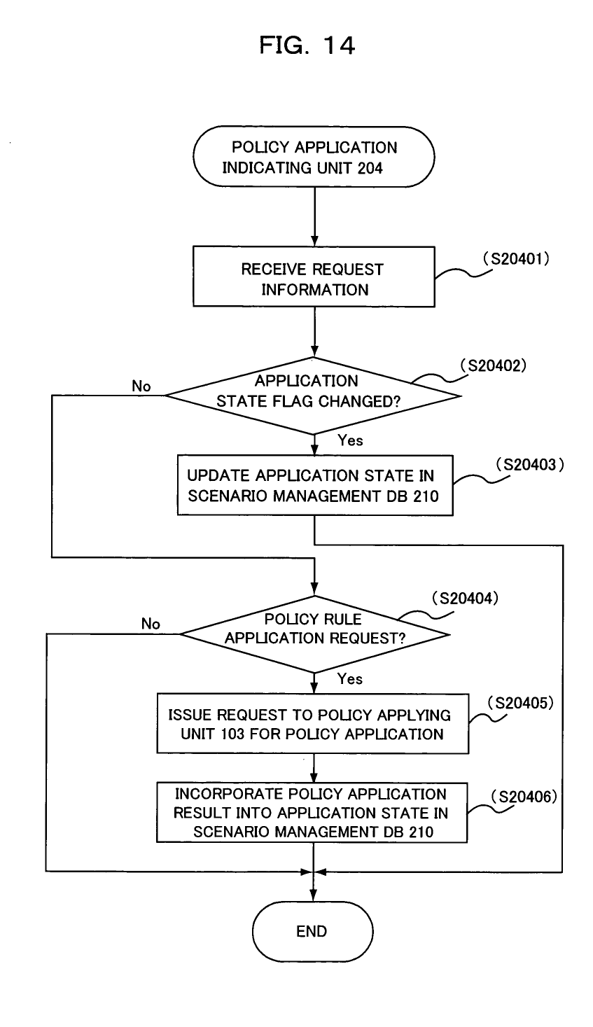

On the other hand, if the policy rule (x) has already been applied (“application success”), the scenario implementing unit 203 issues a request for a scenario management DB change to the policy application indicating unit 204 (step S28 in FIG. 7(A), and step S20304 in FIG. 13), and the policy application indicating unit 204 (step S20401 in FIG. 14) changes the “application state” of the policy rule (x) to “in-application” (step S29 in FIG. 7(A), and Yes route of step S20402 to step S20403 in FIG. 14) and returns a scenario management DB change completion notification to the scenario implementing unit 203 (step S30 in FIG. 7(A)). Upon receipt of this notification, the scenario implementing unit 203 terminates the analysis of the policy rule (x).

Moreover, if the aforesaid policy rule (x) is in “non-application”, the scenario implementing unit 203 makes a decision as to whether or not to apply the “policy application state condition” (step S31 in FIG. 7(B), and step S20305 in FIG. 13). If applied, the scenario implementing unit 203 makes a decision as to whether or not to satisfy the condition (step S32 in FIG. 7(B), and step S20306 in FIG. 13).

In consequence, in the case of no satisfaction of the “policy rule application condition” (No decision in step S32 in FIG. 7(B), and No decision in step S20306 in FIG. 13), the scenario implementing unit 203 terminates the analysis of this policy rule (x), and in the case of the satisfaction thereof, it then issues a network state request to the management information managing unit 304 (Yes route of step S32 to step S33 in FIG. 7(B), and Yes route of step S20306 to step S20307 in FIG. 13). Upon receipt of this request, the management information managing unit 304 reads out the network state from the network management DB 310 (step S34 in FIG. 7(B)) and notifies this network state to the scenario implementing unit 203 (step S36 in FIG. 7(B)).

In addition, on the basis of the notified network state, the scenario implementing unit 203 makes a decision as to whether or not to satisfy the “network state condition” (step S36 in FIG. 7(B), and step S20308 in FIG. 13). If the decision result shows no satisfaction of the “network state condition” (No decision in step S36 in FIG. 7(B), and No decision in step S20308 in FIG. 13), the analysis of this policy rule (x) comes to an end. On the other hand, in the case of the satisfaction thereof (Yes decision in step S36 in FIG. 7(B), and Yes decision in step S20308 in FIG. 13), a policy rule application request is issued to the policy application indicating unit 204 (step S37 in FIG. 7(B), and step S20309 in FIG. 13).

That is, the scenario implementing unit 203 is made to implement the application of the policy rule (x) only when both the “policy rule application state condition” and “network state condition” are satisfied.

When receiving the aforesaid policy rule application request, the policy application indicating unit 204 (step S20401 in FIG. 14) issues the policy rule application request to the policy applying unit 103 (step S38 in FIG. 7(B), and No routes of steps S20402 and S20404 to step S20405 in FIG. 14). Upon receipt of this request, the policy applying unit 103 (step S10301 in FIG. 10) executes the network control on the network device 3 according to the policy rule (x) (step S39 in FIG. 7(B), and step S10302 in FIG. 10).

In addition, the policy applying unit 103 sends a policy application result notification to the policy application indicting unit 204 (step S40 in FIG. 7(B)). Upon receipt of this notification, the policy application indicating unit 204 (step S20401 in FIG. 14) stores the policy application result (“application success” or “application failure”) in the scenario management DB 210 (step S41 in FIG. 7(B), and step S20406 in FIG. 14), and issues a policy rule application completion notification to the scenario implementing unit 203 (step S42 in FIG. 7(B)), while the scenario implementing unit 203 terminates the analysis of this policy rule (x) in response to the completion notification.

Meanwhile, in the policy rule application state decision in the step S27 of FIG. 7(A) and the step S20303 in FIG. 13, if the application state of the policy rule (x) is in a non-applied condition (“application failure”), the scenario implementing unit 203 issues a scenario management DB change request to the policy application indicating unit 204 (step S43 in FIG. 7(A), and step S20304′ in FIG. 13), while the policy application indicating unit 204 changes the “application state” of this policy rule (x) to the “non-application” (step S44 in FIG. 7(A), and step S20403 in FIG. 14), and returns a scenario management DB change completion notification to the scenario implementing unit 203 (step S45 in FIG. 7(A)). Following this, the scenario implementing unit 203 conducts the processing as well as the above-mentioned processing in a case in which the “application state” is “non-application”.

Thus, the scenario implementing unit 203 completes the analysis of one policy rule registered in the scenario. Moreover, the scenario implementing unit 203 repeats the analysis likewise with respect to all the policy rules set in the scenario undergoing the implementation request (Yes route of step S46 in FIG. 7(B), and Yes route of step S20310 in FIG. 13). The policy server 1 implements the scenario in this way.

That is, data comprising combinations of a plurality of types of policy rules, the policy rule implementation results as the respective application conditions and the application conditions depending on the subsequent operating states (network state) of the network device 3 are stored and managed as scenario data in the scenario management DB 210 according to this embodiment, and the scenario implementing unit 203 implements the policy control on the network device 3 on the basis of a given policy rule having the application condition suitable to a monitor result of the network state, and it is capable of implementing the policy control on the network device 3 on the basis of the implementation result thereof and another policy rule having the application condition suitable to the subsequent network state monitor result.

### [C] DESCRIPTION OF CONCRETE EXAMPLE

A description will be given hereinbelow of a concrete example based on the above-described configurations and operations. The switching of LSP (label Switched Path) which will be described in the following explanation signifies that a plurality of paths (LSP) in which the traffic of one user flows are prepared and, in a case in which the use of one path (LSP) falls into difficulty because of congestion or the like, the control of the network device 3 is executed to carry out the switching so that the traffic flows toward a path (LSP) prepared separately.

### (C1) Concrete Example 1

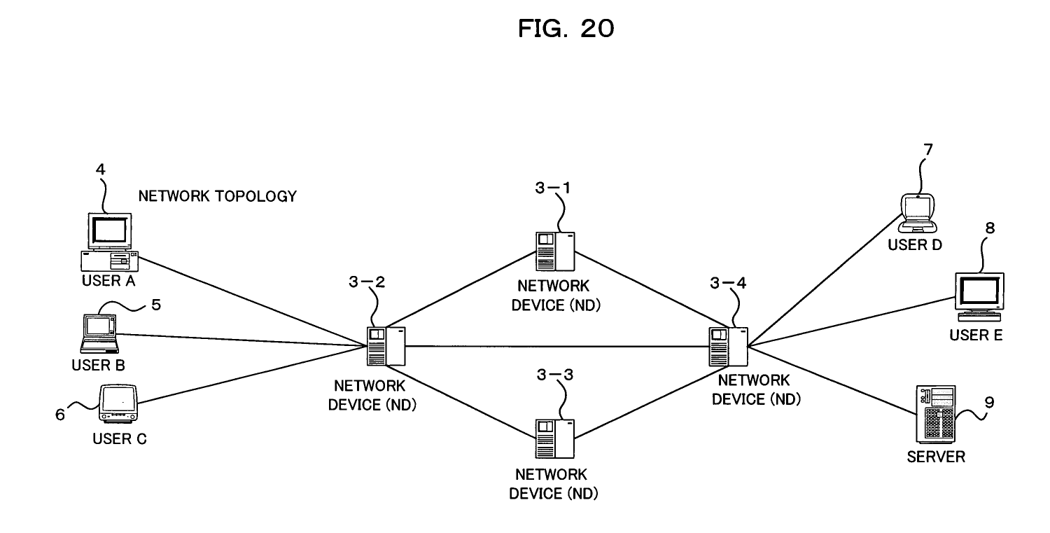

First of all, as a concrete example 1, a description will be given hereinbelow of the implementation of the scenario control according to this embodiment with respect to a network configuration which, for example, as shown in FIG. 20, includes a plurality of (in this case, four) network devices (NDs) 3-1, 3-2, 3-3 and 3-4, user terminals 4, 5 and 6 (users A, B and C) accommodated in the network device 3-2, user terminals 7 and 8 (users D and E) accommodated in the network device 3-4, and a server 9.

In this case, for example, as shown in the Table 3, as usable paths (LSP) from the user A, B or C to the user D, E or the server 9, there are set paths (LSP-X1, LSP-Y1, LSP-Z1) passing through the network device 3-2 and the network device 3-4 and further set paths (LSP-X2, LSP-Y2, LSP-Z2) passing through the network devices 3-2, 3-1 and 3-4. Moreover, in the initial setting of the system, LSP-X1, LSP-Y1 and LSP-Z1 are set to be valid, while LSP-X2, LSP-Y2 and LSP-Z2 are set to be invalid.

TABLE 3
LSP INFORMATION

| | TARGET | | VALID/ |
|---|---|---|---|
| LSP NAME | TRAFFIC | PATH INFORMATION | INVALID |
| LSP-X1 | USER A | ND 3-2 - ND 3-4 | VALID |
| LSP-Y1 | USER B | ND 3-2 - ND 3-4 | VALID |
| LSP-Z1 | USER C | ND 3-2 - ND 3-4 | VALID |
| LSP-X2 | USER A | ND 3-2 - ND 3-1 - ND 3-4 | INVALID |
| LSP-Y2 | USER B | ND 3-2 - ND 3-1 - ND 3-4 | INVALID |
| LSP-Z2 | USER C | ND 3-2 - ND 3-1 - ND 3-4 | INVALID |

First, for example, the network administrator, who manages the network 2, produces, through the use of the user interface unit 101, a policy rule #1 signifying that “the traffic (LSP-X1) of the User A is switched to an alternative path (LSP-X2) when the packet loss rate from the network device 3-2 to the network device 3-4 exceeds 10%” and a policy rule #2 signifying that “the traffic (LSP-Y1) of the User B is switched to an alternative path (LSP-Y2) when the packet loss rate from the network device 3-2 to the network device 3-4 exceeds 10%”, with a policy registration request including the inputted policy rules #1 and #2 being sent to the policy managing unit 102.

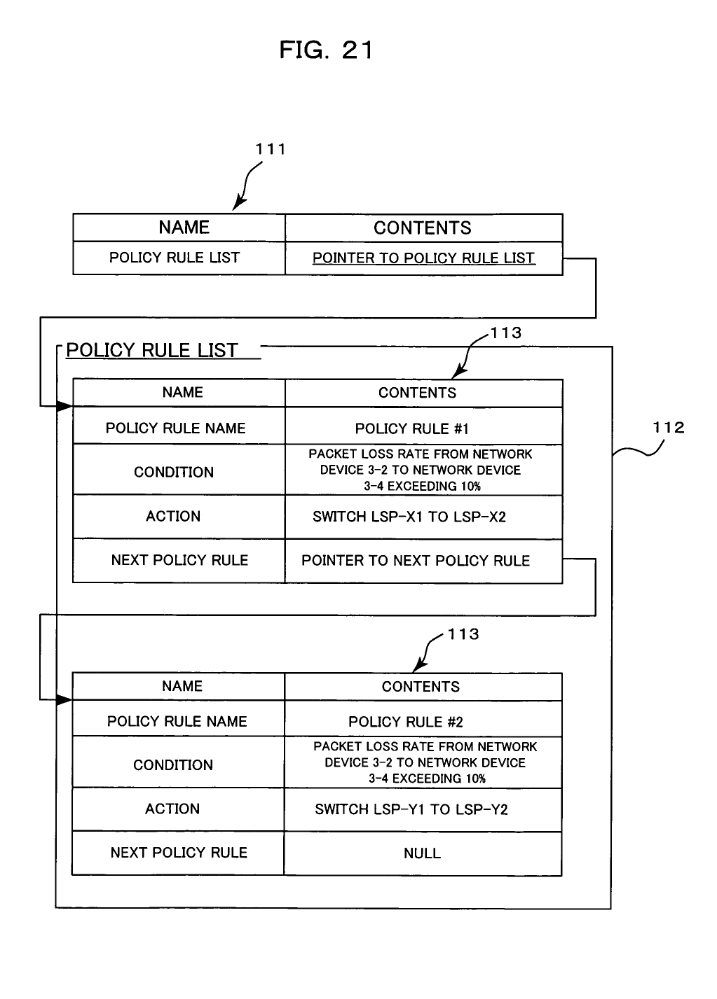

When receiving this registration request therefrom, the policy managing unit 102 stores, in the policy management DB 110, the policy rules #1 and #2 included in this registration request in the form of the policy rule data structure described above with reference to FIG. 2 (see FIG. 21). Moreover, the policy managing unit 102 sends the policy rule registration notification to the policy analyzing unit 201 and, in response to the notification, the policy analyzing unit 201 makes a decision as to whether or not the network state notification has already been requested with respect to the “condition” of the notified policy rule.

If already requested, the policy analyzing unit 201 terminates the processing. On the other hand, if not requested yet, it issues a network state notification request to the monitor point setting unit 301. The monitor point setting unit 301 receives the network state notification request and makes a request to the polling unit 302 for the setting of the collection of information such as traffic and packet loss rate. Upon receipt of this request, the polling unit 302 collects the requested network state information periodically and stores them in the network management DB 310.

Subsequently, the network administrator produces a scenario through the use of the user interface unit 101. The scenario inputting unit 205, when accepting a policy rule acquisition request from the user interface unit 101, first reads out the above-mentioned registered policy rules #1 and #2 from the policy management DB 110 and notifies these policy rules #1 and #2 to the user interface unit 101.

The network administrator combines the registered policy rules #1 and #2 through the use of the user interface unit 101 to produce, for example, scenario data (scenario #1) such that “the network control is executed so that, with respect to the network 2, if a congestion that the packet loss rate exceeds 10% occurs therein, the traffic (LSP-X1) of the user A is switched to the alternative path (LSP-X2) so as to suppress the congestion (policy rule #1) and, still, difficulty is experienced in improving the network congestion, the traffic (LSP-Y1) is further switched to the alternative path (LSP-Y2) (policy rule #2)”.

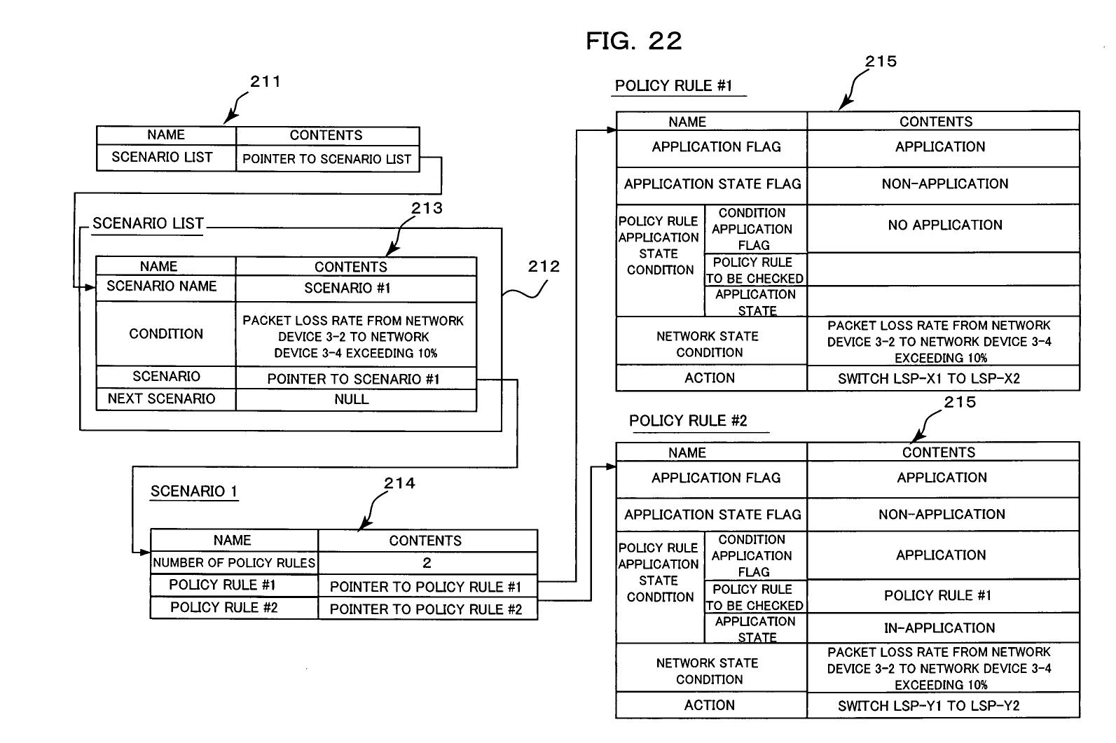

The user interface unit 101 sends a scenario registration request including the produced scenario #1 to the scenario inputting unit 205, and the scenario inputting unit 205 stores, through the use of the scenario data structure mentioned above with reference to FIG. 3, the scenario #1, handed over as the scenario registration request, in the scenario management DB 210 as shown in FIG. 22. That is, only the scenario #1 is registered in the scenario management DB 210, and the policy rule #1 and the policy rule #2 are registered in the scenario #1 in a state associated with each other.

In addition, the scenario inputting unit 205 makes a decision as to whether or not the network state notification has already been requested with respect to the “condition” of the scenario #1. In this case, the “condition” of the scenario #1 are the same (the packet loss rate from the network device 3-2 to the network device 3-4 exceeds 10%) as the condition” of the policy rules #1 and #2 and, hence, the network state notification has already been requested, which terminates the processing.

Still additionally, since the setting has been made for collecting the information such as traffic and packet loss rate in the plurality of network devices 3-2 and 3-4, which are an object (object of monitor) of the “condition” of the policy rules #1, #2 and the scenario #1, and interfaces (not shown) of the network devices 3-2 and 3-4, the management information managing unit 304 operates periodically to make a decision as to whether the network state information has been updated or not, and if updated, transmits the network state notification to the scenario analyzing unit 202.

Now, let it be assumed that the packet loss rate of the traffic from the network device 3-2 to the network device 3-4 exceeds 10%. When receiving a request, the scenario analyzing unit 202 sees the scenario management DB 210 to detect the scenario when the packet loss rate of the traffic from the network device 3-2 to the network device 3-4 has exceeded 10%. In this case, since it is the scenario #1, the scenario analyzing unit 202 transmits an implementation request on the scenario #1 to the scenario implementing unit 203.

Upon receipt of this scenario implementation request, the scenario implementing unit 203 first analyzes the policy rule #1. In this case, as shown in FIG. 22, the “application flag” and the “application state flag” satisfy the condition for the application of the policy rule #1. Moreover, since the “condition application flag” of the “policy rule application state condition” shows “no application”, consideration is not given to the “policy rule application state condition”. Still moreover, since the “network state condition” also satisfies the condition, the scenario implementing unit 203 transmits an application request on the policy rule #1 having the action representing “LSP-X1 is switched to LSP-X2” to the policy application indicating unit 204.

Upon receipt of this application request, the policy application indicating unit 204 transmits an application request on the policy rule #1 to the policy applying unit 103. In response to this request, the policy applying unit 103 applies the policy rule #1 to the corresponding network devices 3-2, 3-1 and 3-4. In this case, let it be assumed that the policy rule #1 is normally applied thereto. Then, the policy applying unit 103 notifies an application result showing “application success” to the policy application indicating unit 204. Upon receipt of the application result, the policy application indicating unit 204 rewrites the “application state flag” of the policy rule #1 as “application success” in the scenario management DB 210, and transmits an application completion notification to the scenario implementing unit 203.

Following this, the scenario analyzing unit 202 analyzes the policy rule #2. In this case, as shown in FIG. 22, the “application flag” and “application state flag” satisfy the condition for the application of the policy rule #2. Moreover, since the “condition application flag” of the “policy rule application state condition” denotes “application”, the scenario analyzing unit 202 checks the “policy rule application state condition”. Now, although the policy rule to be referred to (checked)=“policy rule #1” and “application state”=“in-application”, since, with respect to the policy rule #1, “application state flag”=“application success”, the processing comes to an end without applying the policy rule #2.

After the above-described operations, the implementation of the scenario #1 comes to an end.

Thereafter, in a case in which the packet loss rate of the traffic from the network device 3-2 to the network device 3-4 exceeds 10% although the implementation of the policy rule #1 is made in this way, the implementation of the scenario #1 again takes place. That is, the scenario analyzing unit 202 analyzes the policy rule #1. Since “application state flag”=“application success” although the “application flag” satisfies the condition, the application flag is rewritten as “in-application” and the policy rule #1 is not put into application.

Subsequently, the scenario analyzing unit 202 analyzes the policy rule #2. In this case, the “application flag” and the “application state flag” satisfy the condition. Moreover, the application state of the “policy rule application state condition” is “in-application” and it satisfies the condition. Since the “network state condition” also fulfills the condition, the scenario analyzing unit 202 transmits an application request on the policy rule #2 having “action” representing “LSP-Y1 is switched to LSP-Y2” to the policy application indicating unit 204.

In response to this application request, the policy application indicating unit 204 transmits an application request on the policy rule #2 to the policy applying unit 103. According to this request, the policy applying unit 103 applies the policy rule #2 with respect to the corresponding network devices 3-2, 3-1 and 3-4. In this case, let it be assumed that the policy rule #2 is normally applied thereto. The policy applying unit 103 notifies an application result showing “application success” to the policy application indicating unit 204. Upon receipt of this application result, the policy application indicating unit 204 rewrites the “application state flag” of the policy rule #2 as “application success” in the scenario management DB 210, and transmits an application completion notification to the scenario implementing unit 203.

As described above, when the network administrator defines a scenario so that, in a case in which the policy rule #1 is applied while still failing to improve the network state, another policy rule #2 is automatically applied, the degradation of the network quality becomes preventable.

Incidentally, also in a case in which three or more policy rules are combined and defined as a scenario, as well as the above-described case, the different policy rules are successively applied according to this scenario.

### (C2) Concrete Example 2

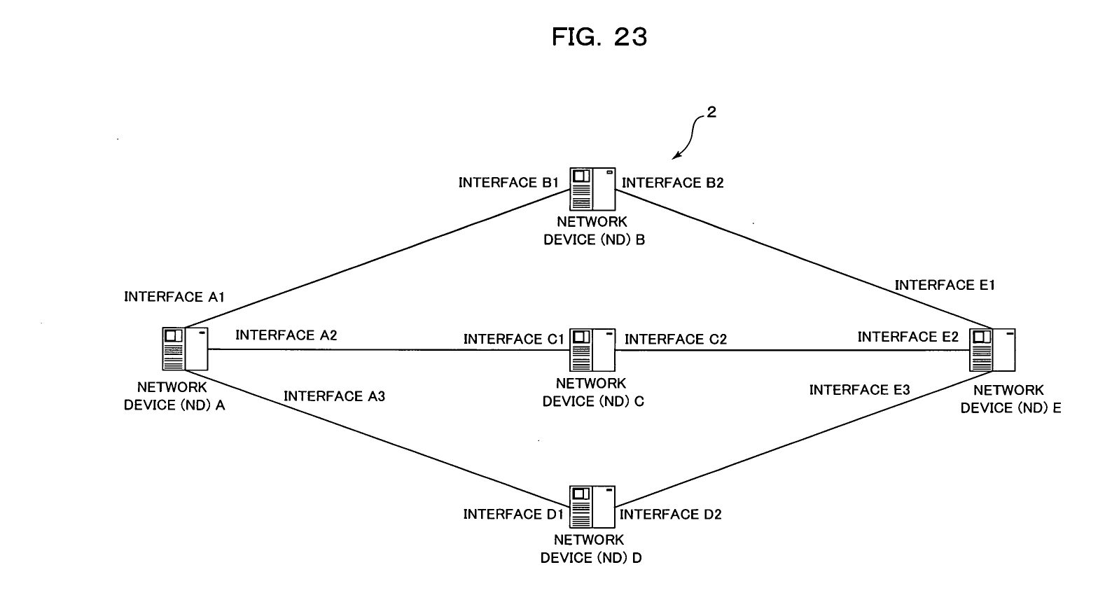

Secondly, as a concrete example 2, a description will be given hereinbelow of the implementation of the scenario control according to this embodiment with respect to a network configuration which, for example, as shown in FIG. 23, includes a plurality of (in this case, five) network devices A, B, C, D and E. In this configuration, the network device A is equipped with interfaces A1, A2 and A3, the network device B has interfaces B1 and B2, the network device C has interfaces C1 and C2, the network device D has interfaces D1 and D2, and the network device E has interfaces E1, E2 and E3.

In this case, as shown in FIG. 23, the network devices A and B are connected to each other through their interfaces A1 and B1, the network devices A and C are connected to each other through their interfaces A2 and C1, and the network devices A and D are connected to each other through their interfaces A3 and D1. Moreover, the network devices B and E are connected to each other through their interfaces B2 and E1, the network devices C and E are connected to each other through their interfaces C2 and E2, and the network devices D and E are connected to each other through their interfaces D2 and E3.

In addition, for example, as shown in the Table 4, as usable paths (LSP) from the network device A to the network device E, there are set LSP-X passing through the network devices A(A1)-(B1)B(B2)-(E1)E, LSP-Y passing through the network devices A(A2)-(C1)C(C2)-(E2)E, and LSP-Z passing through the network devices A (A3)-(D1) D (D2)-(E3) E. Moreover, in the initial setting of the system, LSP-X is set to be valid, while the remaining LSP-Y and LSP-Z are set to be invalid.

TABLE 4
LSP INFORMATION

| LSP NAME | PATH INFORMATION | VALID/INVALID |
|---|---|---|
| LSP-X | A(A1) - (B1)B(B2) - (E1)E | VALID |
| LSP-Y | A(A2) - (C1)C(C2) - (E2)E | INVALID |
| LSP-Z | A(A3) - (D1)D(D2) - (E3)E | INVALID |

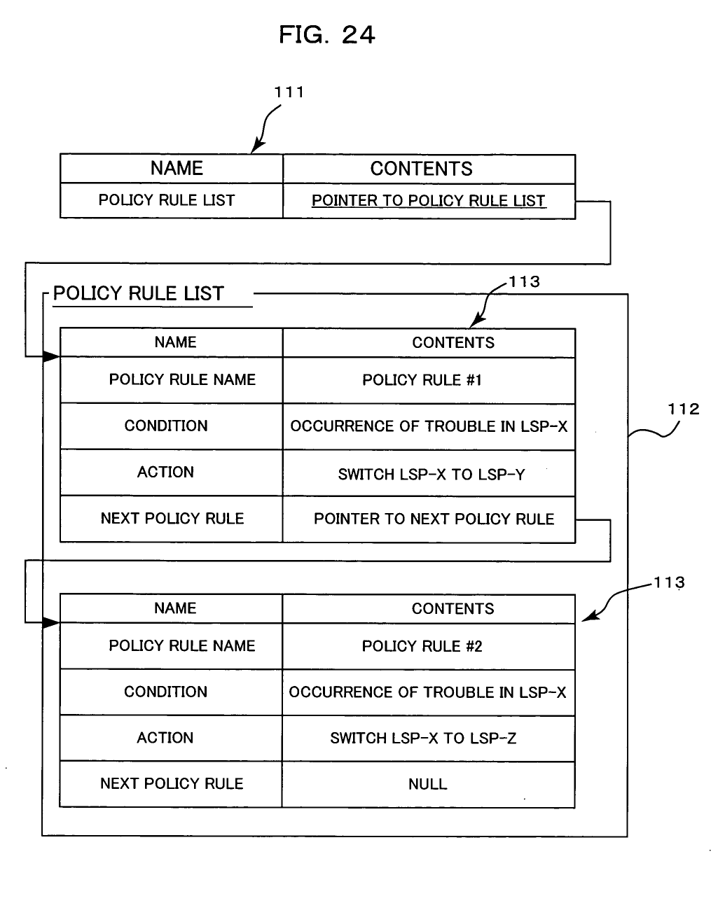

First of all, the network administrator, who manages the network 2 shown in FIG. 3, produces, through the use of the user interface unit 101, the policy rule #1 (if a trouble occurs in a working path (LSP-X), this path (LSP-X) is switched to an alternative path (LSP-Y)”) and the policy rule #2 (if a trouble occurs in a working path (LSP-X), this path (LSP-X) is switched to another alternative path (LSP-Z)”), for example, shown in FIG. 24, and sends a policy rule registration request including these policy rules #1 and #2 to the policy managing unit 102.

Upon receipt of this registration request, the policy managing unit 102 stores, through the use of the policy rule data structure mentioned above with reference to FIG. 2, the policy rules #1 and #2 received as the policy rule registration request in the policy management DB 110 as shown in FIG. 24, and sends a policy rule registration notification to the policy analyzing unit 201. In response to this notification, the policy analyzing unit 201 makes a decision as to whether a network state notification has already been required with respect to the conditions of the policy rules #1 and #2 received therefrom.

If this decision result shows that it has already been requested, the policy analyzing unit 201 terminates the processing. On the other hand, if not requested yet, the policy analyzing unit 201 issues a network state notification request to the monitor point setting unit 301. When receiving this network state notification request, the monitor point setting unit 301 issues a request to the trap unit 303 for the setting of trap of trouble information for the purpose of collecting the trouble information. Upon receipt of this request, the trap unit 303 collects the network state information and stores it in the network management DB 310.

Subsequently, the network administrator produces a scenario through the use of the user interface unit 101. When receiving a policy rule acquisition request from the user interface unit 101, the scenario inputting unit 205 reads out the registered policy rules #1 and #2 from the policy management DB 110 and notifies the registered policy rules #1 and #2 to the user interface unit 101. The network administrator combines the registered policy rules #1 and #2 through the use of the user interface unit 101 to produce scenario data (scenario #1) having the contents in which, for example, “with respect to a network, if a trouble occurs in a given path (working path=LSP-X), this path is switched to an alternative path A (LSP-Y) and, if the switching to the alternative path A falls into failure because of abnormality of the interface of the network or the like, the path is switched to another alternative path B (=LSP-Z)”, and sends a scenario registration request including this scenario #1 to the scenario inputting unit 205.

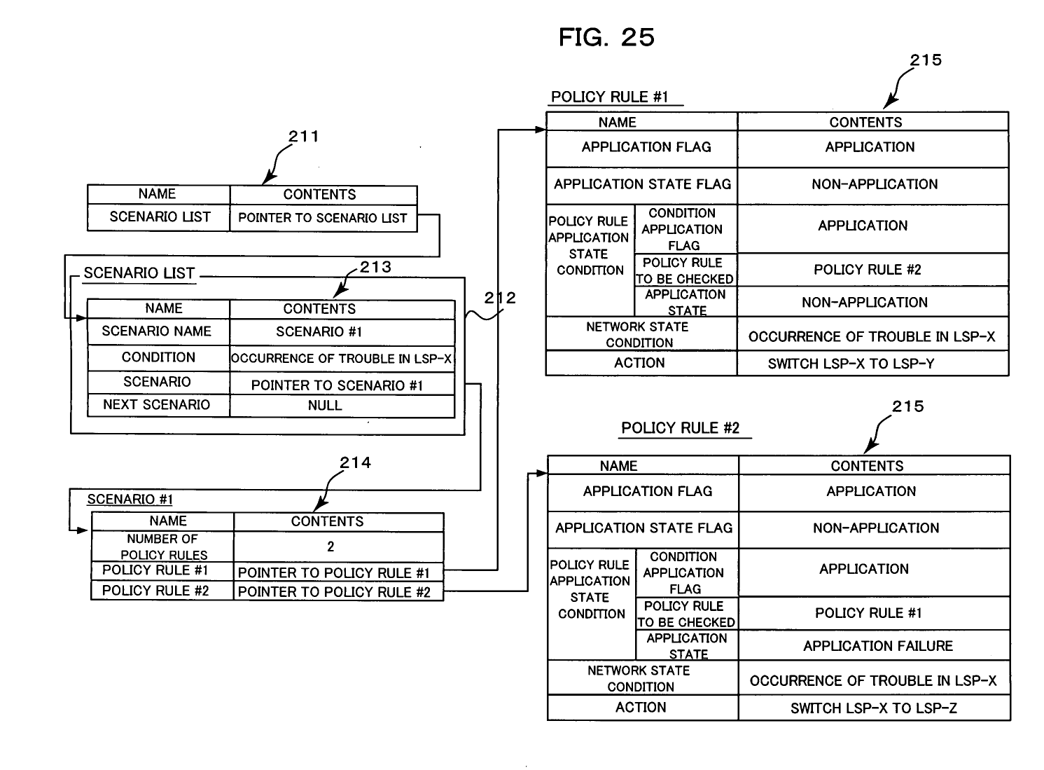

The scenario inputting unit 205, accepting the processing, stores, through the use of the scenario data structure mentioned above with reference to FIG. 3, the scenario #1 received as the scenario registration request in the scenario management DB 210 as shown in FIG. 25. That is, in this case, only the scenario #1 is registered in the scenario management DB 210, and the policy rules #1 and #2 are registered in the scenario #1.

In addition, the scenario inputting unit 205 makes a decision as to whether or not a network state notification has already been requested with respect to the “condition” of the scenario #1. In this case, since the “condition” of the scenario #1 is the same (occurrence of a trouble in LSP-X) as the “condition” of the policy rules #1 and #2 and the request has already been made, the processing comes to an end. Moreover, since the setting has been made to collect information on trouble in the plurality of network devices A, B and E for the designated LSP (LSP-X) (object of monitor) and the interfaces A1, B1, B2 and E1 of these network devices A, B and E, the management information managing unit 304 operates periodically to make a decision as to whether the network state information has been updated or not and, if updated, transmits a network state notification to the scenario analyzing unit 202.

Now, let it be assumed that a trouble occurs in LSP-X. In this case, the scenario analyzing unit 202 receives the request and accesses the scenario management DB 210 to detect the scenario when the trouble has occurred in LSP-X. Since it is the scenario #1 in this case, the scenario analyzing unit 202 transmits an implementation request on the scenario #1 to the scenario implementing unit 203. Upon receipt of this scenario implementation request, the scenario implementing unit 203 first analyzes the policy rule #1 of the scenario #1.

In this case, the “application flag” and “application state flag” meet the policy rule applying condition. Moreover, since the “condition application flag” of the “policy rule application state condition”=“application”, the “policy rule application state condition” undergoes a check. Now, the policy rule to be checked=“policy rule #2” and “application state”=“non-application”, which satisfies the condition. Still moreover, since the “network state condition” also satisfies the condition, it transmits an application request on the policy rule #1 having “action” representing “LSP-X is switched to LSP-Y” to the policy application indicating unit 204.

The policy application indicating unit 204, when receiving this application request, transmits an application request on the policy rule #1 to the policy applying unit 103. In response to this request, the policy applying unit 103 applies the policy rule #1 to the corresponding network devices A, B, E and C. Now, let it be assumed that the application of the policy rule #1 results in a failure. Accordingly, the policy applying unit 103 notifies an application result showing “application failure” to the policy application indicating unit 204. When receiving this application result, the policy application indicating unit 204 rewrites the application state flag of the policy rule #1 as “application failure” in the scenario management DB 210, and transmits an application completion notification to the scenario implementing unit 203.

Upon receipt of this application completion notification, the scenario implementing unit 203 analyzes the policy rule #2. In this case, the “application flag” and “application state flag” meet the condition. Moreover, since the “condition application flag” of the “policy rule application state condition”=“application”, the “policy application state condition” undergoes a check. Now, the policy rule to be referred to (checked)=“policy rule #1” and “application state”=“application failure”, which meets the “policy rule application state condition”. Still moreover, since the “network state condition” also meets the condition, the scenario implementing unit 203 transmits an application request on the policy rule #2 having “action” depicting “LSP-X is switched to LSP-Z” to the policy application indicating unit 204.

Upon receipt of this application request, the policy application indicating unit 204 transmits an application request on the policy rule #2 to the policy applying unit 103. In response to this request, the policy applying unit 103 applies the policy rule #2 to the corresponding network devices A, B, E and D. Let it be assumed that the policy rule #2 is normally applied thereto. Accordingly, the policy applying unit 103 notifies an application result showing “application success” to the policy application indicating unit 204. When receiving this application result, the policy application indicating unit 204 rewrites the “application state flag” of the policy rule #2 as “application success” in the scenario management DB 210, and transmits an application completion notification to the scenario implementing unit 203.

Since no policy rule exists in the scenario any more, the scenario implementing unit 203 terminates the processing.

Owing to the scenario #1 being defined in this way, even if the application of the policy rule #1 results in a failure, the application of another policy rule #2 is feasible, which prevents the network quality from degrading due to the occurrence of a failure of the policy rule application.

### (C3) Concrete Example 3

Furthermore, as a concrete example 3, a description will be given hereinbelow of the implementation of the scenario control according to this embodiment with respect to a network configuration in which, for example, as shown in FIG. 26, a plurality of (in this case, two) network devices 3-1 and 3-2 are provided so that the network device 3-1 accommodates terminals (which will hereinafter be referred to simply as organizational units A, B and C) of organizational units A, B and C while the network device 3-2 accommodates terminals (likewise, referred to simply as organizational units D and E) of organizational units D and E.

In this case, let it be assumed that, as the initial setting of the system, the band assurance between the organizational units is not set in this network 2.

First of all, for example, the network administrator, who manages the network 2 shown in FIG. 26, produces, through the use of the under interface unit 101 of the policy server 1, a policy rule #1 signifying that “if the packet loss rate from the organizational unit A to the organizational unit D is 5% or more but less than 10%, 30 Mbps is assured (secured) as a band from the organizational unit A to the organizational unit D” and a policy rule #2 signifying that “if the packet loss rate from the organizational unit A to the organizational unit D is 10% or more, 50 Mbps is assured (secured) as a band from the organizational unit A to the organizational unit D”, and sends a policy rule registration request including these policy rules #1 and #2 to the policy managing unit 102.

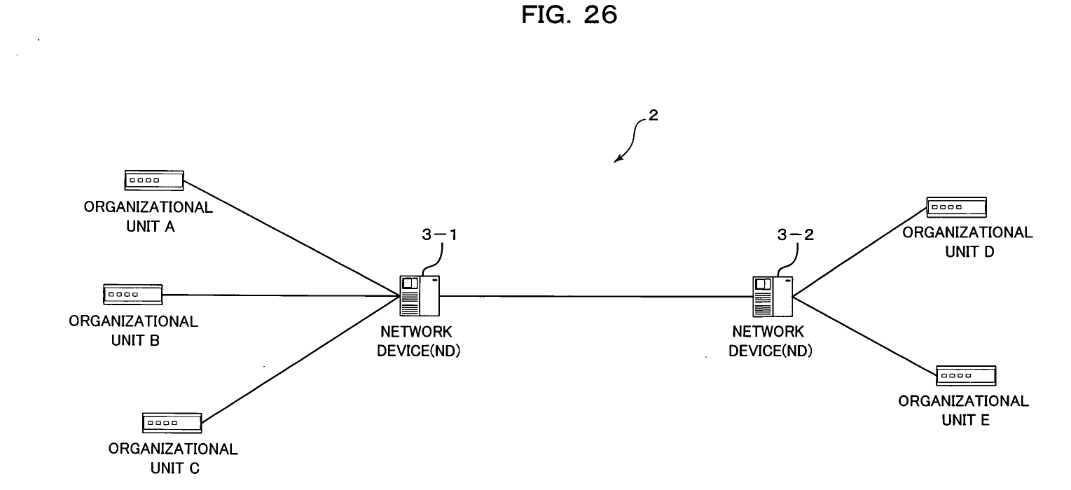

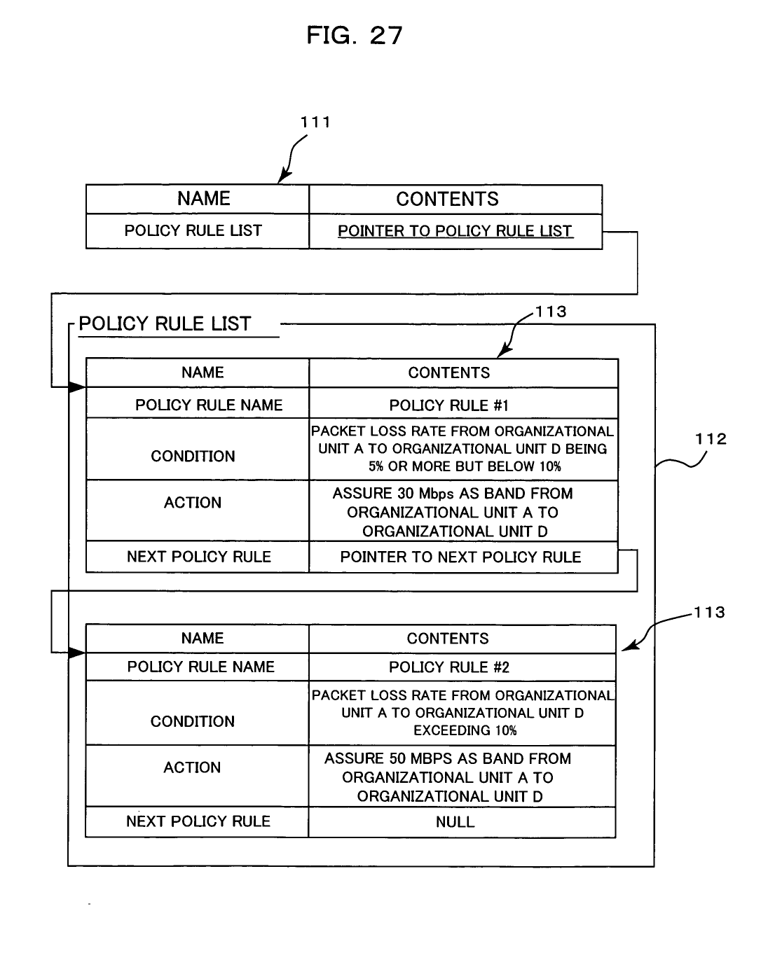

The policy managing unit 102, accepting the processing, stores, through the use of policy rule data structure mentioned above with reference to FIG. 2, the policy rules #1 and #2 handed over as the policy rule registration request in the policy management DB 110 as shown in FIG. 27, and issues a policy rule registration notification to the policy analyzing unit 201. In response to this notification, the policy analyzing unit 201 makes a decision as to whether or not a network state notification has already been requested with respect to the “condition” of the policy rules #1 and #2 handed over. If requested, the policy analyzing unit 201 terminates the processing. On the other hand, If not requested, the policy analyzing unit 201 issues a network state notification request to the monitor point setting unit 301.

Upon receipt of this network state notification request, the monitor point setting unit 301 makes a request to the polling unit 302 for the setting of collection of information such as traffic and packet loss rate. In response to this request, the polling unit 302 collects the requested network state information periodically and stores them in the network management DB 310.

Secondly, the network administrator produces a scenario through the use of the user interface unit 101. First, when receiving a policy rule acquisition request from the user interface unit 101, the scenario inputting unit 205 reads out the registered policy rules #1 and #2 from the policy management DB 110 and notifies the registered policy rules #1 and #2 to the user interface unit 101. The network administrator combines the registered policy rules #1 and #2 through the use of the user interface unit 101 to produce, for example, scenario data (scenario #1) such that “with respect to the network 2, if the packet loss rate is below 10%, the band assurance in traffic between the organizational units A and D which handle important data is set at 30 Mbps, and if it is 10% or more, the band assurance is set at 50 Mbps”, and hands over a scenario registration request including this scenario #1 to the scenario inputting unit 205.

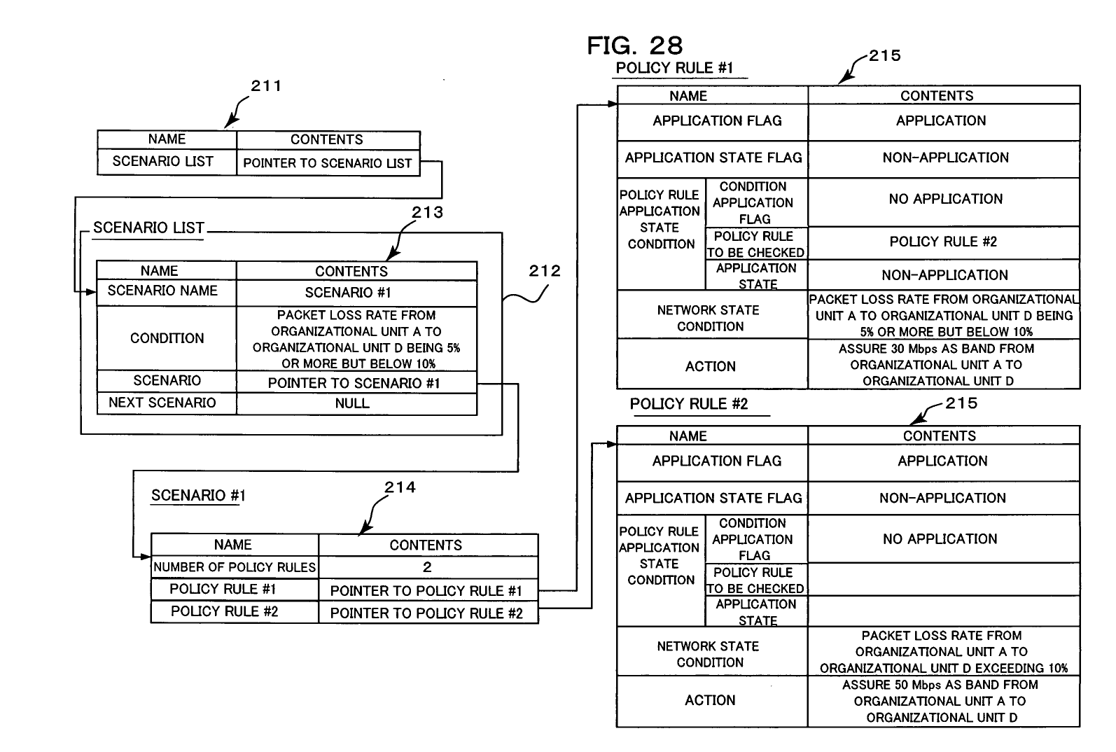

The scenario inputting unit 205, accepting the processing, stores, through the use of the scenario data structure mentioned above with reference to FIG. 3, the scenario #1, handed over as the scenario registration request, in the scenario management DB 210 as shown in FIG. 28. That is, in this case, only the scenario #1 is registered in the scenario management DB 210, and the policy rule #1 and the policy rule #2 are registered in the scenario #1.

In addition, the scenario inputting unit 205 makes a decision as to whether or not the network state notification has already been requested with respect to the “condition” of the scenario #1. If it is not required yet, the scenario inputting unit 205 issues a network state notification request to the monitor point setting unit 301. Upon receipt of this network state notification request, the monitor point setting unit 301 makes a request to the poling unit 302 for the setting of collection of information such as traffic and packet loss rate. According to this request, the polling unit 302 collects the requested network state information periodically to store them in the network management DB 310.

Still additionally, since the setting has been made for collecting the information such as traffic and packet loss rate in the network devices 3-1 and 3-2, which are an object of the “condition” of the policy rules #1, #2 and the scenario #1, and the interfaces of the network devices 3-1 and 3-2, the management information managing unit 304 operates periodically to make a decision as to whether the network state information has been updated or not, and if updated, transmits the network state notification to the scenario analyzing unit 202.

Now, let it be assumed that the traffic between the network device 3-1 and the network device 3-2 exceeds a threshold. Moreover, let it be assumed that, at this time, the packet loss rate from the organizational unit A to the organizational unit D is 12%. In this case, when receiving a request, the scenario analyzing unit 202 sees the scenario management DB 210 to detect the scenario when the traffic between the network device 3-1 and the network device 3-2 has exceeded the threshold. In this case, since it is the scenario #1, the scenario analyzing unit 202 transmits an implementation request on the scenario #1 to the scenario implementing unit 203.

Upon receipt of this scenario implementation request, the scenario implementing unit 203 first analyzes the policy rule #1 of this scenario #1. In this case, the “application flag” and the “application state flag” satisfy the condition for the application of the policy rule #1. Moreover, since the “condition application flag” of the “policy rule application state condition” shows “application”, a check is made with respect to the “policy rule application state condition”. Still moreover, the policy rule to be referred to (checked)=“policy rule #2 and “application state”=“non-application”, which satisfies the condition. However, since the “network state condition” does not satisfy the condition, the application of the policy rule #1 does not take place, and the analysis shifts to the next policy rule #2.

At this time, the “application flag” and “application state flag” satisfy the condition. Since the “condition application flag” of the “policy rule application state condition”=“no application”, consideration is not given to the “policy rule application state condition”. Since the “network state condition” satisfies the condition, it transmits an application request on the policy rule #2 having “action” representing “50 Mbps is assured as the band from the organizational unit A to the organizational unit D” to the policy application indicating unit 204.

Upon receipt of this application request, the policy application indicating unit 204 transmits an application request on the policy rule #2 to the policy applying unit 103. In response to this request, the policy applying unit 103 applies the policy rule #2 to the corresponding network devices 3-1 and 3-2. In this case, let it be assumed that the policy rule #1 is normally implemented. Then, the policy applying unit 103 notifies an application result showing “application success” to the policy application indicating unit 204. Upon receipt of the application result, the policy application indicating unit 204 rewrites the “application state flag” of the policy rule #1 as “application success” in the scenario management DB 210, and transmits an application completion notification to the scenario implementing unit 203.

As described above, in a given network state, a scenario for the selection and application of an optimum policy rule of a plurality of policy rules at that time is defined and produced, thus carrying out a fine policy rule application according to a current network state.

### (C4) Concrete Example 4

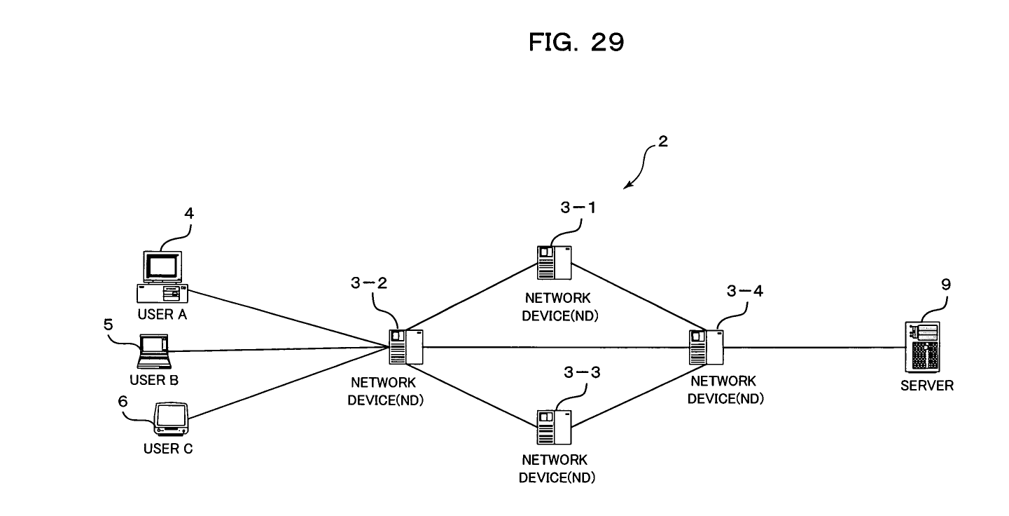

Furthermore, as a concrete example 4, a description will be given hereinbelow of the implementation of the scenario control according to this embodiment with respect to a network configuration which, for example, as shown in FIG. 29, includes a plurality of (in this case, four) network devices 3-1, 3-2, 3-3 and 3-4 so that the network device 3-2 accommodates terminals 4, 5 and 6 of users A, B and C and the network device 3-2 accommodates a server 9.

In this case, for example, as shown in the Table 5, as usable paths (LSP) from the user A, B or C to the server 9, there are set paths (LSP-X1, LSP-Y1, LSP-Z1) passing through the network devices 3-2, 3-1 and 3-4, and paths (LSP-X2, LSP-Y2, LSP-Z2) passing through the network devices 3-2 and 3-4, and paths (LSP-X3, LSP-Y3, LSP-Z3) passing through the network devices 3-2, 3-3 and 3-4. Moreover, in the initial setting of the system, LSP-X1, LSP-Y2 and LSP-Z3 are set to be valid as the traffic of the users A, B and C, while all the remaining paths are set to be invalid.

TABLE 5
LSP INFORMATION

| | TARGET | | VALID/ |
|---|---|---|---|
| LSP NAME | TRAFFIC | PATH INFORMATION | INVALID |
| LSP-X1 | USER A | ND 3-2 - ND 3-1 - ND 3-4 | VALID |
| LSP-Y1 | USER B | ND 3-2 - ND 3-1 - ND 3-4 | INVALID |
| LSP-Z1 | USER C | ND 3-2 - ND 3-1 - ND 3-4 | INVALID |
| LSP-X2 | USER A | ND 3-2 - ND 3-4 | INVALID |
| LSP-Y2 | USER B | ND 3-2 - ND 3-4 | VALID |
| LSP-Z2 | USER C | ND 3-2 - ND 3-4 | INVALID |
| LSP-X3 | USER A | ND 3-2 - ND 3-3 - ND 3-4 | INVALID |
| LSP-Y3 | USER B | ND 3-2 - ND 3-3 - ND 3-4 | INVALID |
| LSP-Z3 | USER C | ND 3-2 - ND 3-3 - ND 3-4 | VALID |

First, for example, the network administrator, who manages the network 2 shown in FIG. 29, produces, through the use of the user interface unit 101, a policy rule #1 having the contents of “if a trouble occurs in a working path (LSP-X1), the working path (LSP-X1) is switched to an alternative path A (LSP-X2)”, a policy rule #2 having the contents of “if a trouble occurs in a working path (LSP-X1), a notification is made through a mail to the network administrator” and a policy rule #3 having the contents of “if the packet loss rate from the network device 3-2 to the network device 3-4 exceeds 10%, an alternative path A (LSP-X2) is switched to another alternative path (LSP-X3)”, and sends a policy rule registration request including these policy rules #1, #2 and #3 to the policy managing unit 102.

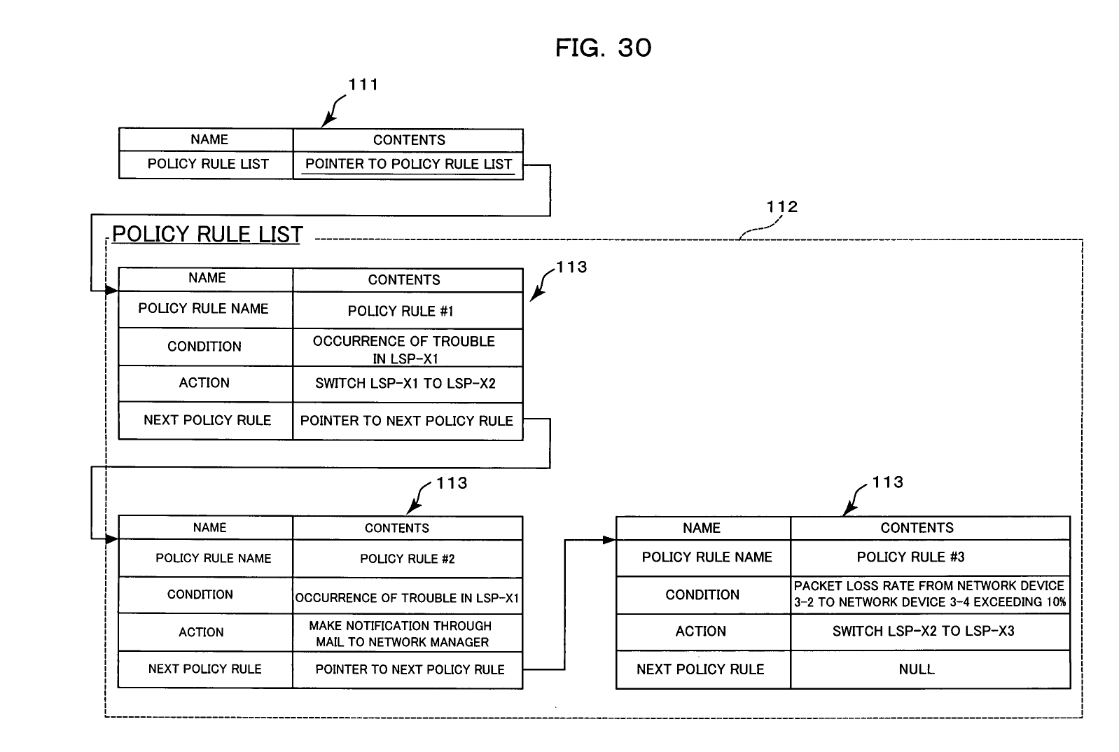

When accepting the processing, the policy managing unit 102 stores, through the use of the policy rule data structure described above with reference to FIG. 2, the policy rules #1, #2 and #3 received as the policy rule registration request in the policy management DB 110 as shown in FIG. 30. Moreover, the policy managing unit 102 sends the policy rule registration request to the policy analyzing unit 201.

In response to this request, the policy analyzing unit 201 makes a decision as to whether or not the network state notification has already been requested with respect to the “condition” of the policy rules #1, #2 and #3 received. If already requested, the policy analyzing unit 201 terminates the processing. On the other hand, If not requested yet, the policy analyzing unit 201 issues a network state notification request to the monitor point setting unit 301. Upon receipt of this network state notification request, the monitor point setting unit 301 makes a request to the polling unit 302 for the setting of collection of information such as traffic and packet loss rate and further makes a request to the trap unit 303 for the setting of trap of trouble information for the purpose of collecting the trouble information. In response to this request, the polling unit 302 collects the requested network state information periodically and stores them in the network management DB 310. Moreover, upon receipt of the request, the trap unit 303 collects the network state information and stores them in the network management DB 310.

Secondly, the network administrator produces a scenario through the use of the user interface unit 101. That is, first, when receiving a policy rule acquisition request from the user interface unit 101, the scenario inputting unit 205 reads out the registered policy rules #1, #2 and #3 from the policy management DB 110 and notifies the registered policy rules #1, #2 and #3 to the user interface unit 101.

The network administrator combines the registered policy rules #1, #2 and #3 through the use of the user interface unit 101 to produce, for example, scenario data (scenario #1) having the contents of “if a trouble occurs in a given path (working path LSP-X1), this path (LSP-X1) is first switched to an alternative path A and a trouble notification is made to the network administrator, and if a network congestion occurs (the packet loss rate exceeds 10%) because the switching to the alternative path A, the path is switched to another alternative path B (LSP-X3)”, and hands over a scenario registration request including this scenario #1 to the scenario inputting unit 205.

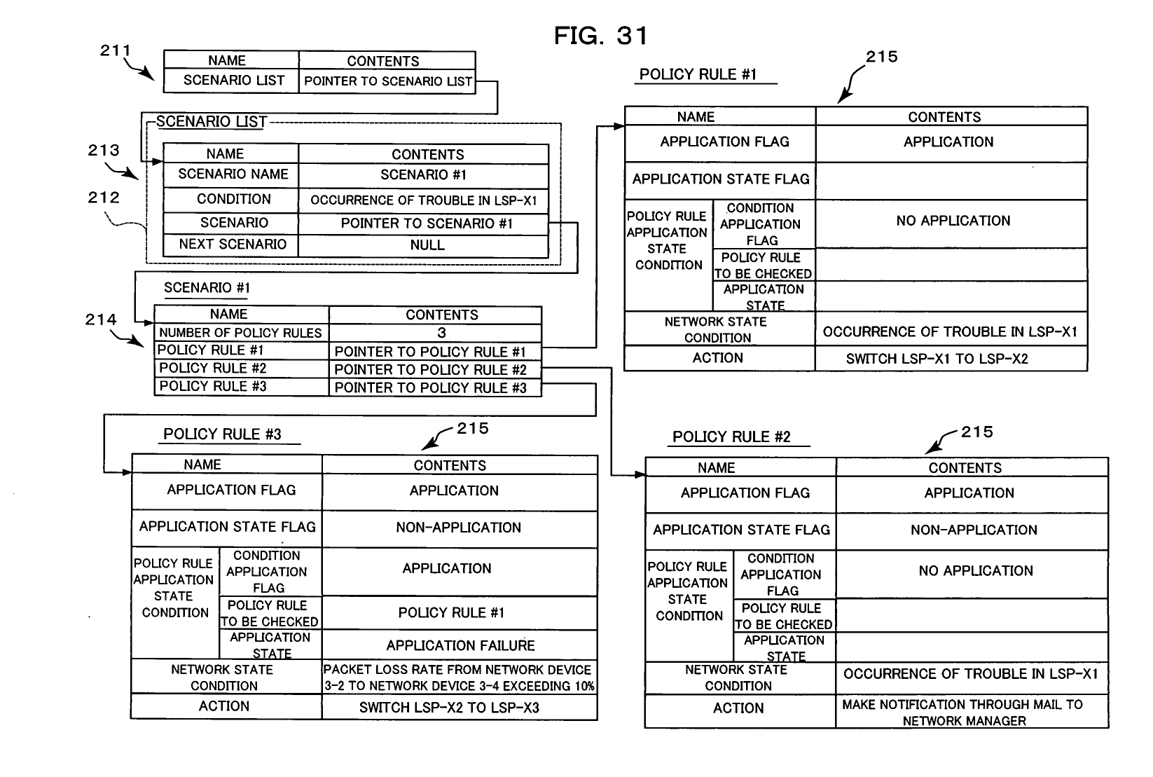

The scenario inputting unit 205, accepting the processing, stores, through the use of the scenario data structure mentioned above with reference to FIG. 3, the scenario #1, received as the scenario registration request, in the scenario management DB 210 as shown in FIG. 31. That is, in this case, only the scenario #1 is registered in the scenario management DB 210, and the policy rules #1, #2 and #3 are registered in the scenario #1.

In addition, the scenario inputting unit 205 makes a decision as to whether or not the network state notification has already been requested with respect to the “condition” of the scenario #1. At this time, the “condition” of the scenario #1 is the same (occurrence of a trouble in LSP-X1) as the “condition” of the policy rules #1, #2 and #3 and, since the notification has already been requested, the processing comes to an end.

Still additionally, since the setting has been made for collecting the information, such as traffic and packet loss rate, and the trouble information in the network devices 302, 3-1 and 3-4, which are an object of the “condition” of the policy rules #1, #2, #3 and the scenario #1, and the interfaces of the network devices 3-2, 3-1, 3-4, the management information managing unit 304 operates periodically to make a decision as to whether the network state information has been updated or not, and if updated, transmits a network state notification to the scenario analyzing unit 202.

Now, let it be assumed that a trouble occurs in LSP-X1. In this case, the scenario analyzing unit 202 receives the request and sees the scenario management DB 210 to detect the scenario when the trouble has occurred in LSP-X1. Since it is the scenario #1 in this case, the scenario analyzing unit 202 transmits an implementation request on the scenario #1 to the scenario implementing unit 203. Upon receipt of this scenario implementation request, the scenario implementing unit 203 first analyzes the policy rule #1 of the scenario #1.

At this time, the “application flag” and “application state flag” meet the condition for the application of the policy rule #1. Moreover, since the “condition flag” of the “policy rule application state condition”=“no application”, consideration is not given to the “policy rule application state condition”. Still moreover, since the “network state condition” also satisfies the condition, the scenario implementing unit 203 transmits an application request on the policy rule #1 having “action” representing “LSP-X1 is switched to LSP-X2” to the policy application indicating unit 204.

The policy application indicating unit 204, when receiving this request, transmits an application request on the policy rule #1 to the policy applying unit 103. In response to this request, the policy applying unit 103 applies the policy rule #1 to the corresponding network devices 3-2, 3-1 and 3-4. Now, let it be assumed that the policy rule #1 is normally applied thereto. Accordingly, the policy applying unit 103 notifies an application result showing “application success” to the policy application indicating unit 204. When receiving this application result, the policy application indicating unit 204 rewrites the “application state flag” of the policy rule #1 as “application success” in the scenario management DB 210, and transmits an application completion notification to the scenario implementing unit 203.

Subsequently, the scenario implementing unit 203 analyzes the policy rule #2. In this case, the “application flag” and “application state flag” meet the condition. Moreover, since the “condition application flag” of the “policy rule application state condition”=“no application”, no consideration is given to the “policy application state condition”. Still moreover, since the “network state condition” also meets the condition, the scenario implementing unit 203 transmits an application request on the policy rule #2 having “action” depicting “notification is made through a mail to the network administrator” to the policy application indicating unit 204.

Upon receipt of this request, the policy application indicating unit 204 transmits an application request on the policy rule #2 to the policy applying unit 103. In response to this request, the policy applying unit 103 applies the policy rule #2. In this case, let it be assumed that the policy rule #2 is normally applied thereto. Accordingly, the policy applying unit 103 notifies an application result showing “application success” to the policy application indicating unit 204. Upon receipt of this application result, the policy application indicating unit 204 rewrites the “application flag” of the policy rule #2 as “application success” in the scenario management DB 210, and transmits an application completion notification to the scenario implementing unit 203.

Secondly, the scenario implementing unit 203 analyzes the policy rule #3. In this case, the “application flag” and “application state flag” meet the condition. Moreover, since the “condition application flag” of the “policy rule application state condition”=“application”, a check is made with respect to the “policy rule application state condition”. At this time, although the policy rule to be referred to (checked)=“policy rule #1” and “application state”=“in-application”, since the “application state flag” of the policy rule #1=“application success”, the processing comes to an end without applying the policy rule #3.

The implementation of the scenario #1 comes to an end in this way.

At this time, let it be assumed that, because of the application of the policy rule #1, the packet loss rate of the traffic from the network device 3-2 to the network device 3-4 exceeds 10%. In this case, assuming that the occurrence of the trouble remains in LSP-X1, the implementation of the scenario #1 again takes place.

That is, the scenario implementing unit 203 first analyzes the policy rule #1. In this case, although the “application flag” meets the condition, since “application flag”=“application success”, the “application state flag” is rewritten as “in-application” and the policy rule #1 is not applied. Following this, the scenario implementing unit 203 analyzes the policy rule #2. Also in this case, as well as the policy rule #1, since “application state flag” is “application success”, it is rewritten as “in-application” and the policy rule #2 is not applied.

Subsequently, the scenario implementing unit 203 analyzes the policy rule #3. In this case, the “application flag” and “application state flag” fulfill the condition. Moreover, since the “condition application flag” of the “policy rule application state condition”=“application”, a check is made with respect to the “policy rule application state condition”. At this time, the policy rule to be referred to (checked)=“policy rule #1” and “application state”=“in-application”, which fulfills the condition. Since the “network state condition” also fulfills the condition, the scenario implementing unit 203 transmits an application request on the policy rule #3 having “action” signifying “LSP-X2 is switched to LSP-X3” to the policy application indicating unit 204.

In response to this request, the policy application indicating unit 204 transmits an application request on the policy rule #3 to the policy applying unit 103. According to this request, the policy applying unit 103 applies the policy rule #3. In this case, let it be assumed that the policy rule #3 is normally applied thereto. Accordingly, the policy applying unit 103 informs the policy application indicating unit 204 of an application result showing “application success”. Upon receipt of this application result, the policy application indicating unit 204 rewrites the “application state flag” of the policy rule #3 as “application success” in the scenario management DB 210, and transmits an application completion notification to the scenario implementing unit 203.

The second implementation of the scenario #1 comes to an end after the above-described operations.

When the scenario #1 is defined in this way, the continuous application of the policy rules #1, #2 and #3 becomes feasible at the occurrence of a trouble. Moreover, for preventing the quality of the network 2 from degrading due to the policy rule application, the status of the influence of the policy rule application on the network 2 is checked, thus applying a different policy rule.

As described above, according to this embodiment, the network administrator can utilize the policy rules prepared in advance to freely produce (customize) a scenario for realizing an optimum policy rule selection algorithm according to a network operating state, and a network operation (control), the network administrator desires, is realizable through the implementation of this scenario, which enables coping flexibly with diverse network operations.

In particular, according to this embodiment, it is possible to automatically execute the network control flexibly and finely to cope validly with the network state varying at all times, thereby securing the service quality of the network 2 without increasing the management load on the network administrator. Moreover, for example, in a case in which the application of the policy rule results in a failure, or if the policy rule is applied while still not improving the network state, a scenario is defined so as to apply another policy rule, thus preventing the deterioration of the network service quality.

[D] Description of Example of Scenario Production Screen

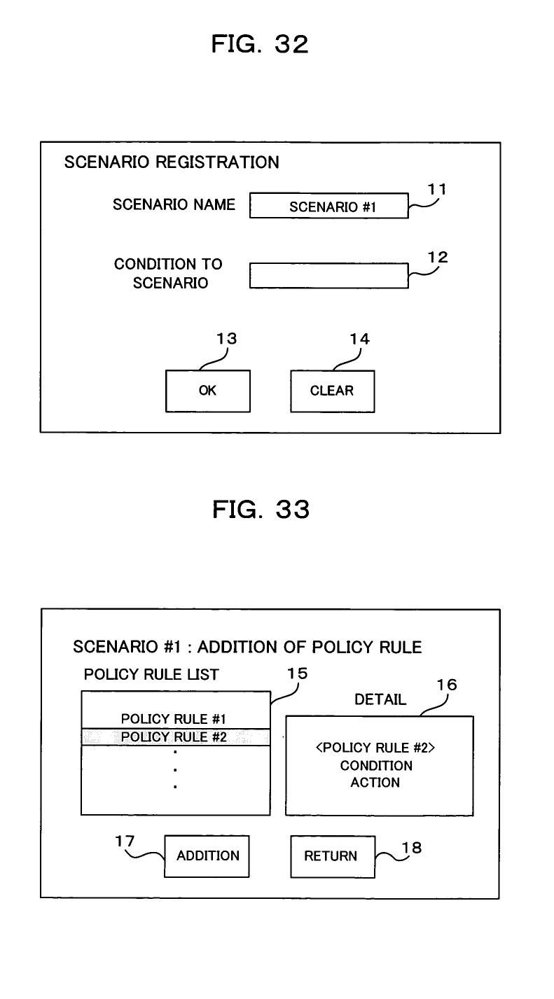

With reference to FIGS. 32 to 36, as examples, a description will be given hereinbelow of inputting screens, the network administrator uses, for the scenario production in the policy server 1 according to the above-described concrete examples 1 to 4.

The network administrator inputs, through the use of the user interface unit 101 of the policy server 1, necessary data in an inputting screen (scenario registration screen), for example, shown in FIG. 32, that is, in a server screen showing an inputting form having inputting columns 11, 12 and the like on “scenario name” and “condition for scenario”, and clicks (selects) a “OK” button 13 through the use of a mouse or the like when the inputting reaches completion. A “clear” button 14 is for clearing the previously inputted data when an inputting mistake or the like occurs.

Subsequently, when the network administrator clocks the aforesaid “OK” button, an additional policy rule screen showing a policy rule list (menu) 15 stored in the policy management DB 110 and detail information 16 on a policy rule selected from this list 15 appears, for example, as shown in FIG. 33. The network administrator selects a policy rule to be added in the list 15 and confirms the detail information 16 before clicking an “addition” button 17, thereby conducting the necessary additional processing on the policy rule. In FIG. 33, a “return” button 18 is for returning the appearing screen to the previous screen (scenario registration screen shown in FIG. 32).

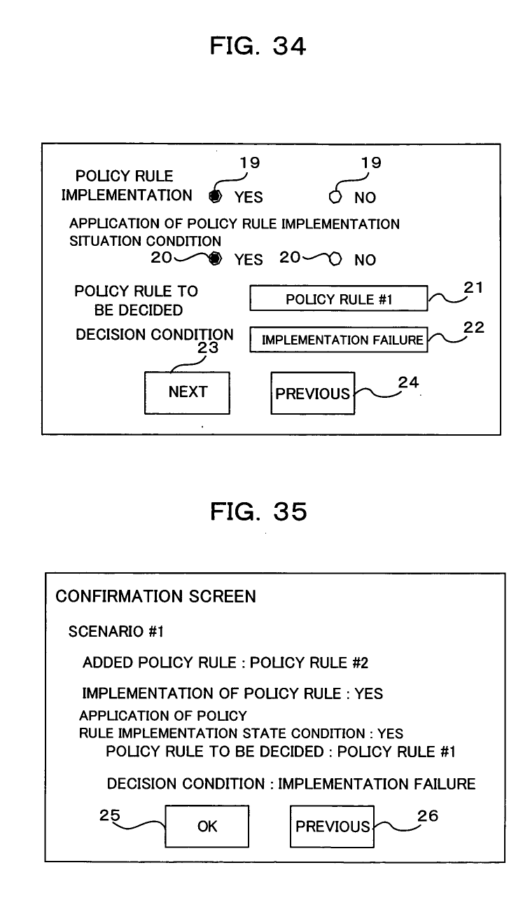

Following this, through the selection of the aforesaid “addition” button 17, for example, as shown in FIG. 34, there appears an inputting form (decision condition inputting screen) including a check box 19 for selecting (setting) whether or not to implement the policy rule, a check box 20 for selecting (setting) whether or not to apply the policy rule implementation state condition, an inputting column 21 for the policy rule which is an object of decision, an inputting column 22 for decision condition, and others. The network administrator inputs the necessary data in this inputting form. FIG. 34 shows a state of the inputting of data including “policy rule implementation”=“yes”, “application of policy rule implementation state condition”=“yes”, “policy rule being an object of decision”=“policy rule #1” and “decision condition”=“implementation failure”.

When the inputting reaches completion, for example, the network administrator clicks and selects a “next” button 23 to make a next screen appear, while selecting a “return” button 24 if there is a need to redo the inputting on the previous screen (see FIG. 33). In the case of the selection of the “next” button 23, as shown in FIG. 35, a previously inputted contents confirmation screen appears in the server screen, and the network administrator selects an “OK” button 25 after confirming the contents, while, if a correction or the like is necessary, the network administrator selects a “return” button 26 for correcting the inputted contents properly.

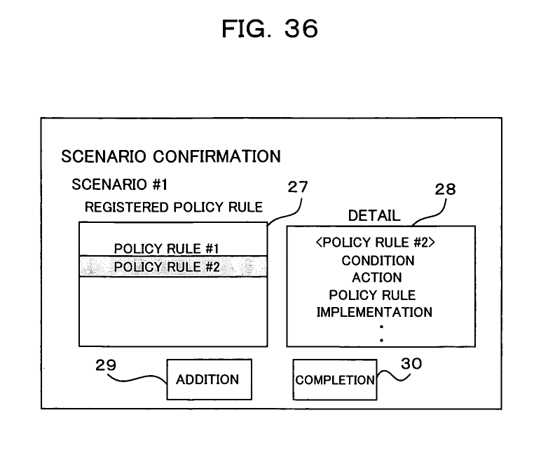

In the case of the selection of the “OK” button 25, for example, as shown in FIG. 36, on the server screen, there appear a scenario confirmation screen including a list 27 of the policy rules registered in the scenario and detail information 28 thereon. The network administrator selects a “completion” button 30 if the inputted contents of the scenario are correct and the scenario production processing is to be terminated, so the scenario production processing comes to an end. In a case in which there are other policy rules to be added to this scenario, the network administrator selects an “addition” button 29. In response to the selection of the “addition” button 29, the policy rule addition screen appears as shown in FIG. 36, and the network administrator subsequently inputs necessary data in like manner until the policy rules to be added run out.

Incidentally, the above-mentioned inputting format is only one example and, naturally, other inputting formats are also acceptable.

As described above in detail, according to the present invention, it is possible to automatically execute the network control flexibly and finely to cope validly with the network state varying at all times, which can provide means extremely useful in the fields of network communications.

[E] Others

It should be understood that the present invention is not limited to the above-described embodiment and concrete examples, and that it is intended to cover all changes and modifications of the embodiments of the invention herein which do not constitute departures from the spirit and scope of the invention.

1. A policy rule scenario control apparatus comprising:
scenario data storing means storing one or more scenario data produced by combining a plurality of types of policy rules for policy control on a network device and applying conditions of said policy rules;
monitoring means monitoring an operating state of said network device;
scenario selecting means selecting, from said scenario data storing means, said scenario data having the applying condition suitable to a monitor result in said monitoring means; and
scenario implementing means implementing said policy control with respect to said network device on the basis of, in said scenario data selected by said scenario selecting means, said policy rule having the applying condition suitable to said monitor result, and implementing said policy control with respect to said network device on the basis of a result of the implementation and a different policy rule having the applying condition suitable to a subsequent monitor result in said monitoring means.

2. A policy rule scenario control apparatus comprising:
policy data storing means storing, as policy data, a plurality of types of policy rules for policy control on a network device;
scenario data storing means storing one or more scenario data produced by combining said plurality of types of policy rules and applying conditions of said policy rules;
scenario inputting means receiving an input of the applying conditions of the policy data and combining the plurality of types of policy data in said policy data storing means and the applying conditions to produce said scenario data and register said scenario data in said scenario data storing means;
monitoring means monitoring an operating state of said network device;
scenario selecting means selecting, from said scenario data storing means, the scenario data having the applying condition corresponding to a monitor result in said monitoring means; and
scenario implementing means implementing said policy control with respect to said network device on the basis of, in said scenario data selected by said scenario selecting means, the policy rule having the applying condition suitable to said monitor result, and implementing said policy control with respect to said network device on the basis of a result of the implementation and a different policy rule having the applying condition suitable to a subsequent monitor result in said monitoring means.

3. A policy rule scenario control method comprising the steps of:
storing, in scenario data storing means, one or more scenario data produced by combining a plurality of types of policy rules for policy control on a network device and applying conditions of said policy rules;
monitoring an operating state of said network device;
selecting, from said scenario data storing means, the scenario data having the applying condition corresponding to a result of the monitoring;
implementing said policy control with respect to said network device on the basis of, in the selected scenario data, the policy rule having the applying condition suitable to said monitoring result; and
implementing said policy control with respect to said network device on the basis of a result of the implementation and a different policy rule having the applying condition suitable to a subsequent monitoring result.

4. A policy rule scenario control method comprising the steps of:
storing, in policy data storing means, a plurality of types of policy rules as policy data for policy control on a network device, and storing, in scenario data storing means, a plurality of scenario data produced by combining said plurality of types of policy rules and applying conditions of said policy rules;
upon receipt of an input of the applying conditions of said policy data, combining said plurality of types of policy data in said policy data storing means and said applying conditions to produce said scenario data and register said scenario data in said scenario data storing means;
monitoring an operating state of said network device;
selecting, from said scenario data storing means, the scenario data having the applying condition corresponding to a result of the monitoring;
implementing said policy control with respect to said network device on the basis of, in the selected scenario data, the policy rule having the applying condition suitable to the monitoring result; and
implementing said policy control with respect to said network device on the basis of the implementation result and a different policy rule having the applying condition suitable to a subsequent monitoring result.
